(19) United States
(12) Patent Application Publication
(10) Pub. No.: US 2023/0344847 A1
(43) Pub. Date: Oct. 26, 2023

(54) DETECTION DEVICE, VEHICLE, DETECTION METHOD, AND DETECTION PROGRAM

(71) Applicants: Autonetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Yoshihiro HAMADA, Osaka-shi, Osaka (JP); Hiroshi UEDA, Yokkaichi-shi, Mie (JP)

(73) Assignees: Autonetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 17/924,356

(22) PCT Filed: Mar. 30, 2021
(86) PCT No.: PCT/JP2021/013437

§ 371 Date: Nov. 10, 2022

(30) Foreign Application Priority Data
May 18, 2020 (JP) 2020-086520

(51) Int. Cl. H04L 9/40; B60R 16/023

(52) U.S. Cl. CPC H04L 63/1425; B60R 16/023

(57) ABSTRACT

A detection device includes: a message acquisition unit configured to acquire one or a plurality of transmission messages in the in-vehicle network; a data acquisition unit configured to acquire a set of a plurality of types of data that are included in the transmission messages and that correspond to the same time; a storage unit configured to store therein a detection condition being based on a plurality of the sets that respectively correspond to a plurality of times; a calculation unit configured to calculate an estimated error of the data of a type to be monitored in the set, based on the set and the detection condition; and a determination unit configured to determine whether or not the transmission message corresponding to the data of the type to be monitored is an unauthorized message, based on the estimated error and on an estimated error that was calculated in the past.

### TECHNICAL FIELD

The present disclosure relates to a detection device, a vehicle, a detection method, and a detection program.

This application claims priority on Japanese Patent Application No. 2020-86520 filed on May 18, 2020, the entire content of which is incorporated herein by reference.

### BACKGROUND ART

PATENT LITERATURE 1 (Japanese Laid-Open Patent Publication No. 2019-29961) discloses a detection device as follows. That is, this detection device is a detection device for detecting an unauthorized message in an in-vehicle network mounted in a vehicle. The detection device includes: a message acquisition unit that acquires one or a plurality of transmission messages in the in-vehicle network; a data acquisition unit that acquires a set of a plurality of types of data that are included in the transmission messages acquired by the message acquisition unit and that correspond to the same time; a storage unit that stores therein a detection condition that is created in advance and is based on a plurality of the sets that respectively correspond to a plurality of times; and a detection unit that detects the unauthorized message, based on the set acquired by the data acquisition unit and the detection condition.

### CITATION LIST

### Patent Literature

PATENT LITERATURE 1: Japanese Laid-Open Patent Publication No. 2019-29961

### SUMMARY OF THE INVENTION

A detection device according to the present disclosure is configured to detect an unauthorized message in an in-vehicle network mounted in a vehicle, and includes: a message acquisition unit configured to acquire one or a plurality of transmission messages in the in-vehicle network; a data acquisition unit configured to acquire a set of a plurality of types of data that are included in the transmission messages acquired by the message acquisition unit and that correspond to the same time; a storage unit configured to store therein a detection condition, the detection condition having been created in advance and based on a plurality of the sets that respectively correspond to a plurality of times; a calculation unit configured to calculate an estimated error of the data of a type to be monitored in the set, based on the set acquired by the data acquisition unit and on the detection condition; and a determination unit configured to determine whether or not the transmission message corresponding to the data of the type to be monitored is an unauthorized message, based on the estimated error calculated by the calculation unit and on an estimated error that was calculated in the past by the calculation unit.

A detection method according to the present disclosure is a detection method to be performed in a detection device that includes a storage unit and is configured to detect an unauthorized message in an in-vehicle network mounted in a vehicle. The detection method includes: acquiring one or a plurality of transmission messages in the in-vehicle network; and acquiring a set of a plurality of types of data that are included in the acquired transmission messages and that correspond to the same time. The storage unit stores therein a detection condition, the detection condition having been created in advance and based on a plurality of the sets that respectively correspond to a plurality of times. The detection method further includes: calculating an estimated error of the data of a type to be monitored in the set, based on the acquired set and the detection condition; and determining whether or not the transmission message corresponding to the data of the type to be monitored is an unauthorized message, based on the calculated estimated error and an estimated error that was calculated in the past.

A detection program according to the present disclosure is a detection program to be used in a detection device that includes a storage unit and is configured to detect an unauthorized message in an in-vehicle network mounted in a vehicle. The detection program causes a computer to function as: a message acquisition unit configured to acquire one or a plurality of transmission messages in the in-vehicle network; and a data acquisition unit configured to acquire a set of a plurality of types of data that are included in the transmission messages acquired by the message acquisition unit and that correspond to the same time. The storage unit stores therein a detection condition, the detection condition having been created in advance and based on a plurality of the sets that respectively correspond to a plurality of times. The detection program further causes the computer to function as: a calculation unit configured to calculate an estimated error of the data of a type to be monitored in the set, based on the set acquired by the data acquisition unit and on the detection condition; and a determination unit configured to determine whether or not the transmission message corresponding to the data of the type to be monitored is an unauthorized message, based on the estimated error calculated by the calculation unit and on an estimated error that was calculated in the past by the calculation unit.

One mode of the present disclosure can be realized not only as a detection device including such a characteristic processing unit but also as an in-vehicle communication system including the detection device. One mode of the present disclosure can be realized as a semiconductor integrated circuit that realizes a part or the entirety of the detection device.

### BRIEF DESCRIPTION OF DRAWINGS

FIG. 1 shows a configuration of an in-vehicle communication system according to a first embodiment of the present disclosure.

FIG. 2 shows a configuration of a bus connection device group according to the first embodiment of the present disclosure.

FIG. 3 shows a configuration of a gateway device in the in-vehicle communication system according to the first embodiment of the present disclosure.

FIG. 4 illustrates a creation process of a normal model to be used by the gateway device according to the first embodiment of the present disclosure.

FIG. 5 illustrates timings at which a synchronization process is performed in the gateway device according to the first embodiment of the present disclosure.

FIG. 6 illustrates timings at which a synchronization process is performed in the gateway device according to the first embodiment of the present disclosure.

FIG. 7 illustrates a creation process in a learning phase of the normal model according to the first embodiment of the present disclosure.

FIG. 8 illustrates a verification process in a test phase of the normal model according to the first embodiment of the present disclosure.

FIG. 9 illustrates an unauthorized message detection process using the normal model according to the first embodiment of the present disclosure.

FIG. 10 illustrates a creation process in a learning phase with respect to a modification of the normal model according to the first embodiment of the present disclosure.

FIG. 11 illustrates an unauthorized message detection process using a modification of the normal model according to the first embodiment of the present disclosure.

FIG. 12 is a flowchart of a procedure of operation performed when the gateway device according to the first embodiment of the present disclosure receives a transmission message.

FIG. 13 is a flowchart of a procedure of operation performed when the gateway device according to the first embodiment of the present disclosure has stored a received transmission message in a storage unit.

FIG. 14 shows a configuration of a gateway device in an in-vehicle communication system according to a second embodiment of the present disclosure.

FIG. 15 shows an example of temporal change in a transmission interval of a periodic message to be monitored in the in-vehicle communication system according to the second embodiment of the present disclosure.

FIG. 16 shows an example of a frequency distribution of target message transmission intervals in the in-vehicle communication system according to the second embodiment of the present disclosure.

FIG. 17 shows an example of unauthorized message detection by a detection unit in the gateway device according to the second embodiment of the present disclosure.

FIG. 18 is a flowchart of a procedure of operation performed when the gateway device according to the second embodiment of the present disclosure receives a target message.

FIG. 19 is a flowchart of a procedure of operation performed when the gateway device according to the second embodiment of the present disclosure performs a determination process.

### DETAILED DESCRIPTION

To date, a detection device for detecting an unauthorized message in an in-vehicle network has been developed.

### Problems to be Solved by the Present Disclosure

Beyond the technology described in PATENT LITERATURE 1, a technology capable of more accurately detecting an unauthorized message in an in-vehicle network is demanded.

The present disclosure has been made in order to solve the above-described problem. An object of the present disclosure is to provide a detection device, a vehicle, a detection method, and a detection program capable of more accurately detecting an unauthorized message in an in-vehicle network.

### Effects of the Present Disclosure

According to the present disclosure, an unauthorized message in an in-vehicle network can be more accurately detected.

### DESCRIPTION OF EMBODIMENTS OF THE PRESENT DISCLOSURE

First, contents of embodiments of the present disclosure are listed and described.

(1) A detection device according to an embodiment of the present disclosure is configured to detect an unauthorized message in an in-vehicle network mounted in a vehicle, and includes: a message acquisition unit configured to acquire one or a plurality of transmission messages in the in-vehicle network; a data acquisition unit configured to acquire a set of a plurality of types of data that are included in the transmission messages acquired by the message acquisition unit and that correspond to the same time; a storage unit configured to store therein a detection condition, the detection condition having been created in advance and based on a plurality of the sets that respectively correspond to a plurality of times; a calculation unit configured to calculate an estimated error of the data of a type to be monitored in the set, based on the set acquired by the data acquisition unit and on the detection condition; and a determination unit configured to determine whether or not the transmission message corresponding to the data of the type to be monitored is an unauthorized message, based on the estimated error calculated by the calculation unit and on an estimated error that was calculated in the past by the calculation unit.

In the above configuration, an estimated error of the data of the type to be monitored in the set of the plurality of types of data is calculated, and whether or not the transmission message corresponding to the data is an unauthorized message is determined based on the calculated estimated error and an estimated error calculated in the past. Therefore, for example, when compared with the conventional technology in which whether or not a transmission message is an unauthorized message is determined based on authenticity of a current estimated error, the above configuration can reduce an adverse effect of a sudden change of data on the determination result, whereby the detection performance can be improved. Therefore, an unauthorized message in the in-vehicle network can be more accurately detected.

(2) Preferably, the calculation unit calculates an evaluation value regarding authenticity of the data of the type to be monitored, based on the calculated estimated error and on a distribution of the estimated error created by using the detection condition, and the determination unit determines whether or not the transmission message corresponding to the data of the type to be monitored is an unauthorized message, based on the evaluation value calculated by the calculation unit and on an evaluation value that was calculated in the past by the calculation unit.

In the above configuration, an unauthorized message in the in-vehicle network can be more accurately detected based on the current evaluation value and the past evaluation value.

(3) Preferably, the determination unit calculates a moving average of the estimated error, based on the estimated error calculated by the calculation unit and on an estimated error that was calculated in the past by the calculation unit, and determines whether or not the transmission message corresponding to the data of the type to be monitored is an unauthorized message, based on the calculated moving average.

In the above configuration, an unauthorized message in the in-vehicle network can be more accurately detected based on the moving average based on the current estimated error and the past estimated error.

(4) Preferably, the detection condition is created based on the sets of a plurality of types of data that have a predetermined correlation.

In the above configuration, the detection condition is created based on the sets of a plurality of types of data between which some relationship exists. Therefore, it is possible to create a detection condition that allows, based on certain data in a set, reduction in the range of the values that other data in the set can take. This allows the authenticity of the other data to be more accurately determined. That is, an appropriate detection condition can be created.

(5) More preferably, the calculation unit calculates an evaluation value regarding authenticity of the data of the type to be monitored, based on the calculated estimated error and on a distribution of the estimated error created by using the detection condition, and the determination unit determines whether or not the transmission message corresponding to the data of the type to be monitored is an unauthorized message, based on the evaluation value calculated by the calculation unit and on an evaluation value that was calculated in the past by the calculation unit.

In the above configuration, for example, even when an attacker has modified part of data in the data of the type to be monitored and the plurality of types of correlation data, it is possible to determine an abnormality of data in the above set, based on the relationship between the modified data and the residual data. That is, in order to make illegal intrusion, the attacker has to modify all of the data of the type to be monitored and the plurality of types of correlation data. Thus, illegal intrusion into the in-vehicle network can be made difficult. Therefore, security in the in-vehicle network can be improved.

(6) More preferably, when there are a plurality of types of correlation data that are data having the correlation with the data of the type to be monitored, a plurality of detection conditions are created based on the data of the type to be monitored and on the plurality of types of the correlation data.

In the above configuration, illegal intrusion into the in-vehicle network can be made difficult, and the calculation load in creating the detection condition can be reduced.

(7) Preferably, the data is status data indicating a state.

In the above configuration, for example, when the status data of the type to be monitored has a value indicating a state that discontinuously changes, such as a gear shift position or a seat belt state, whether or not the transmission message corresponding to the status data of the type to be monitored is an unauthorized message can be more accurately determined.

(8) Preferably, the data acquisition unit acquires a set of the plurality of types of data respectively included in the transmission messages that are different from each other.

A plurality of types of data whose reception times, transmission times, creation times, or the like are different from each other are respectively included in different transmission messages in many cases. In the above configuration, the types of data to be detected can be prevented from being restricted because of time.

(9) More preferably, the message acquisition unit stores, in the storage unit, the plurality of transmission messages having been acquired, and the data acquisition unit acquires the set from the transmission messages stored in the storage unit.

In the above configuration, for example, data in the plurality of transmission messages stored in the storage unit can be resampled, and therefore, the times of a plurality of types of data can be adjusted to the same time. Thus, a set of a plurality of types of data corresponding to the same time can be easily acquired.

(10) Preferably, the detection device further includes: a monitoring unit configured to monitor the transmission messages in the in-vehicle network; and a distribution acquisition unit configured to acquire a distribution of transmission intervals of the transmission messages. The determination unit detects an unauthorized message, based on a monitoring result by the monitoring unit and on the distribution acquired by the distribution acquisition unit. With respect to a transmission message that has been determined, based on the distribution, by the determination unit as not to be treated as an unauthorized message, the calculation unit calculates the estimated error of the data stored in the transmission message. The determination unit determines whether or not the transmission message, which has been determined, based on the distribution, as not to be treated as an unauthorized message, is an unauthorized message, based on the estimated error calculated by the calculation unit and on the estimated error that was calculated in the past by the calculation unit.

A transmission message that has a pseudo transmission interval accurately adjusted is difficult to be detected as an unauthorized message, based on the monitoring result and the distribution described above. In the above configuration, such a transmission message can be detected as an unauthorized message, based on the set and the detection condition described above. Therefore, security in the in-vehicle network can be improved.

(11) A vehicle according to the embodiment of the present disclosure includes the above-described detection device.

In the above configuration, an unauthorized message in the in-vehicle network can be more accurately detected in the vehicle including the detection device.

(12) A detection method according to the embodiment of the present disclosure is a detection method to be performed in a detection device that includes a storage unit and is configured to detect an unauthorized message in an in-vehicle network mounted in a vehicle. The detection method includes: acquiring one or a plurality of transmission messages in the in-vehicle network; and acquiring a set of a plurality of types of data that are included in the acquired transmission messages and that correspond to the same time. The storage unit stores therein a detection condition, the detection condition having been created in advance and based on a plurality of the sets that respectively correspond to a plurality of times. The detection method further includes: calculating an estimated error of the data of a type to be monitored in the set, based on the acquired set and the detection condition; and determining whether or not the transmission message corresponding to the data of the type to be monitored is an unauthorized message, based on the calculated estimated error and an estimated error that was calculated in the past.

In the above method, an estimated error of the data of the type to be monitored in the set of the plurality of types of data is calculated, and whether or not the transmission message corresponding to the data is an unauthorized message is determined based on the calculated estimated error and an estimated error calculated in the past. Therefore, for example, when compared with the conventional technology in which whether or not a transmission message is an unauthorized message is determined based on authenticity of a current estimated error, the above method can reduce an adverse effect of a sudden change of data on the determination result, whereby the detection performance can be improved. Therefore, an unauthorized message in the in-vehicle network can be more accurately detected.

(13) A detection program according to the embodiment of the present disclosure is a detection program to be used in a detection device that includes a storage unit and is configured to detect an unauthorized message in an in-vehicle network mounted in a vehicle. The detection program causes a computer to function as: a message acquisition unit configured to acquire one or a plurality of transmission messages in the in-vehicle network; and a data acquisition unit configured to acquire a set of a plurality of types of data that are included in the transmission messages acquired by the message acquisition unit and that correspond to the same time. The storage unit stores therein a detection condition, the detection condition having been created in advance and based on a plurality of the sets that respectively correspond to a plurality of times. The detection program further causes the computer to function as: a calculation unit configured to calculate an estimated error of the data of a type to be monitored in the set, based on the set acquired by the data acquisition unit and on the detection condition; and a determination unit configured to determine whether or not the transmission message corresponding to the data of the type to be monitored is an unauthorized message, based on the estimated error calculated by the calculation unit and on an estimated error that was calculated in the past by the calculation unit.

In the above configuration, an estimated error of the data of the type to be monitored in the set of the plurality of types of data is calculated, and whether or not the transmission message corresponding to the data is an unauthorized message is determined based on the calculated estimated error and an estimated error calculated in the past. Therefore, for example, when compared with the conventional technology in which whether or not a transmission message is an unauthorized message is determined based on authenticity of a current estimated error, the above configuration can reduce an adverse effect of a sudden change of data on the determination result, whereby the detection performance can be improved. Therefore, an unauthorized message in the in-vehicle network can be more accurately detected.

Hereinafter, embodiments of the present disclosure will be described with reference to the drawings. In the drawings, the same or corresponding parts are denoted by the same reference signs, and descriptions thereof are not repeated. At least some parts of the embodiments described below may be combined together as desired.

### First Embodiment

[Configuration and Basic Operation]

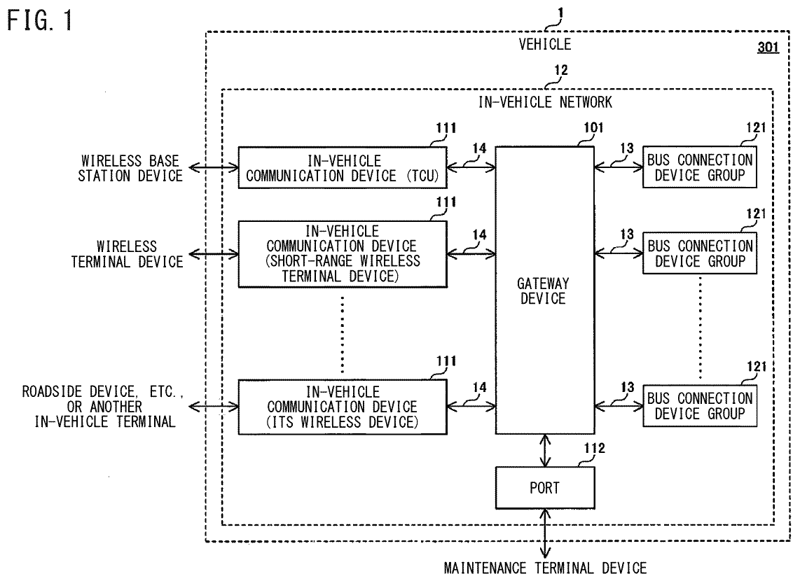

FIG. 1 shows a configuration of an in-vehicle communication system according to a first embodiment of the present disclosure.

With reference to FIG. 1, an in-vehicle communication system 301 includes a gateway device 101, a plurality of in-vehicle communication devices 111, and a plurality of bus connection device groups 121.

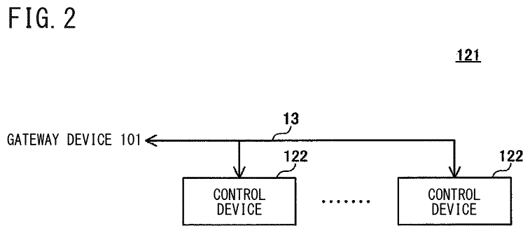

FIG. 2 shows a configuration of a bus connection device group according to the first embodiment of the present disclosure.

With reference to FIG. 2, the bus connection device group 121 includes a plurality of control devices 122. The bus connection device group 121 may not necessarily include a plurality of control devices 122, and may include one control device 122.

The in-vehicle communication system 301 is mounted in a vehicle 1 that travels on a road. An in-vehicle network 12 includes a plurality of in-vehicle devices that are devices inside the vehicle 1. Specifically, the in-vehicle network 12 includes a plurality of in-vehicle communication devices 111 and a plurality of control devices 122 which are examples of the in-vehicle devices.

As long as the in-vehicle network 12 includes a plurality of in-vehicle devices, the in-vehicle network 12 may be configured to include a plurality of in-vehicle communication devices 111 and not to include any control device 122, may be configured not to include any in-vehicle communication device 111 and to include a plurality of control devices 122, or may be configured to include one in-vehicle communication device 111 and one control device 122.

In the in-vehicle network 12, the in-vehicle communication device 111 communicates with a device outside the vehicle 1, for example. Specifically, the in-vehicle communication device 111 is a TCU (Telematics Communication Unit), a short-range wireless terminal device, or an ITS (Intelligent Transport Systems) wireless device, for example.

The TCU can perform wireless communication with a wireless base station device in accordance with a communication standard such as LTE (Long Term Evolution) or 3G, for example, and can perform communication with the gateway device 101. The TCU relays information to be used in services such as navigation, vehicle burglar prevention, remote maintenance, and FOTA (Firmware Over The Air), for example.

For example, the short-range wireless terminal device can perform wireless communication with a wireless terminal device such as a smartphone held by a person in the vehicle 1, i.e., an occupant, in accordance with a communication standard such as Wi-Fi (registered trade mark) and Bluetooth (registered trade mark), and can perform communication with the gateway device 101. The short-range wireless terminal device relays information to be used in services such as entertainment, for example.

For example, the short-range wireless terminal device can perform wireless communication with a wireless terminal device such as a smart key held by the occupant and with a wireless terminal device provided on a tire, in accordance with a predetermined communication standard, by using a radio wave in an LF (Low Frequency) band or a UHF (Ultra High Frequency) band, and can perform communication with the gateway device 101. The short-range wireless terminal device relays information to be used in services such as smart entry and TPMS (Tire Pressure Monitoring System), for example.

The ITS wireless device can perform roadside-to-vehicle communication with a roadside device, such as an optical beacon, a radio wave beacon, or an ITS spot, provided in the vicinity of a road, can perform vehicle-to-vehicle communication with an in-vehicle terminal mounted in another vehicle, and can perform communication with the gateway device 101, for example. The ITS wireless device relays information to be used in services such as congestion alleviation, safe driving support, and route guidance, for example.

For example, the gateway device 101 can, via a port 112, transmit/receive data for update or the like of firmware, and data, etc., accumulated by the gateway device 101 to/from a maintenance terminal device outside the vehicle 1.

The gateway device 101 is connected to in-vehicle devices via transmission lines 13, 14, for example. Specifically, for example, the transmission lines 13, 14 are based on a standard of CAN (Controller Area Network) (registered trade mark), FlexRay (registered trade mark), MOST (Media Oriented Systems Transport) (registered trade mark), Ethernet (registered trade mark), LIN (Local Interconnect Network), or the like.

In this example, each in-vehicle communication device 111 is connected to the gateway device 101 via a corresponding transmission line 14 according to the Ethernet standard. Each control device 122 in each bus connection device group 121 is connected to the gateway device 101 via a corresponding transmission line 13 according to the CAN standard. The control device 122 can control a function unit in the vehicle 1, for example.

The transmission lines 13 are provided for respective types of systems, for example. Specifically, the transmission lines 13 are implemented as a drive-related bus, a chassis/safety-related bus, a body/electrical-equipment-related bus, and an AV/information-related bus, for example.

An engine control device, an AT (Automatic Transmission) control device, and an HEV (Hybrid Electric Vehicle) control device, which are examples of the control device 122, are connected to the drive-related bus. The engine control device, the AT control device, and the HEV control device control an engine, an AT, and switching between the engine and a motor, respectively.

A brake control device, a chassis control device, and a steering control device, which are examples of the control device 122, are connected to the chassis/safety-related bus. The brake control device, the chassis control device, and the steering control device control a brake, a chassis, and steering, respectively.

An instrument indication control device, an air conditioner control device, a burglar prevention control device, an air bag control device, and a smart entry control device, which are examples of the control device 122, are connected to the body/electrical-equipment-related bus. The instrument indication control device, the air conditioner control device, the burglar prevention control device, the air bag control device, and the smart entry control device control instruments, an air conditioner, a burglar prevention mechanism, an air bag mechanism, and smart entry, respectively.

A navigation control device, an audio control device, an ETC (Electronic Toll Collection System) (registered trade mark) control device, and a telephone control device, which are examples of the control device 122, are connected to the AV/information-related bus. The navigation control device, the audio control device, the ETC control device, and the telephone control device control a navigation device, an audio device, an ETC device, and a mobile phone, respectively.

The transmission line 13 may not necessarily have the control devices 122 connected thereto, and may have connected thereto a device other than the control devices 122, for example, a sensor.

The gateway device 101 is a central gateway (CGW), for example, and can perform communication with the in-vehicle devices.

The gateway device 101 performs a relay process of relaying information transmitted/received between control devices 122 that are connected to different transmission lines 13 in the vehicle 1, information transmitted/received between in-vehicle communication devices 111, and information transmitted/received between a control device 122 and an in-vehicle communication device 111, for example.

More specifically, in the vehicle 1, for example, a message is periodically transmitted from an in-vehicle device to another in-vehicle device in accordance with a predetermined rule. In this example, a message that is periodically transmitted from a control device 122 to another control device 122 is described. However, the same applies to a message that is transmitted between a control device 122 and an in-vehicle communication device 111, and a message that is transmitted between in-vehicle communication devices 111.

Transmission of the message may be performed by broadcast or unicast. Hereinafter, the message periodically transmitted is also referred to as a periodic message.

In the vehicle 1, in addition to the periodic message, a message that is non-periodically transmitted from a control device 122 to another control device 122 exists. Each message includes an ID for identifying a transmission source or the like and the content of the message. Whether or not a message is a periodic message can be identified by the ID.

[Gateway Device]

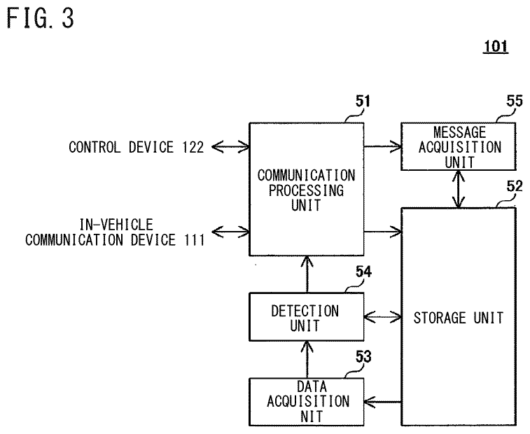

FIG. 3 shows a configuration of the gateway device in the in-vehicle communication system according to the first embodiment of the present disclosure.

With reference to FIG. 3, the gateway device 101 includes a communication processing unit 51, a storage unit 52, a data acquisition unit 53, a detection unit 54, and a message acquisition unit 55. The communication processing unit 51, the data acquisition unit 53, the detection unit 54, and the message acquisition unit 55 are realized by a processor such as a CPU (Central Processing Unit) or a DSP (Digital Signal Processor), for example. The storage unit 52 is a nonvolatile memory, for example. The detection unit 54 is an example of a calculation unit, and an example of a determination unit.

The gateway device 101 functions as a detection device, and detects an unauthorized message in the in-vehicle network 12 mounted in the vehicle 1.

Specifically, the communication processing unit 51 in the gateway device 101 performs a relay process. More specifically, upon receiving a message from a control device 122 via a corresponding transmission line 13, the communication processing unit 51 transmits the received message to another control device 122 via a corresponding transmission line 13.

[Message Acquisition Unit]

The message acquisition unit 55 acquires a plurality of transmission messages in the in-vehicle network 12. The message acquisition unit 55 stores the acquired plurality of transmission messages in the storage unit 52, for example.

More specifically, the storage unit 52 has, registered therein, detection condition information that includes the type of data to be acquired by the message acquisition unit 55, for example. Details of the detection condition information will be described later.

The message acquisition unit 55 recognizes the type of data to be acquired by itself, based on the detection condition information registered in the storage unit 52.

The message acquisition unit 55 monitors data included in a message relayed by the communication processing unit 51, and performs the following process every time the message acquisition unit 51 detects a message that includes data of the type to be acquired.

That is, the message acquisition unit 55 acquires the detected message from the communication processing unit 51, and attaches, to the acquired message, a time stamp indicating the reception time of the message.

Then, the message acquisition unit 55 stores, in the storage unit 52, the message having the time stamp attached thereto.

[Storage Unit]

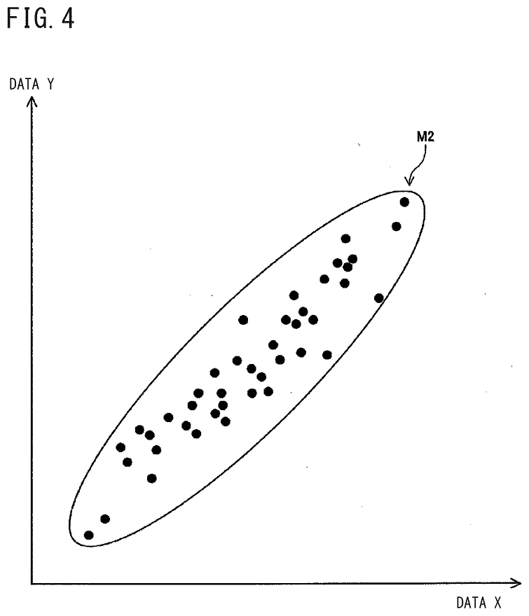

FIG. 4 is a diagram illustrating a creation process of a normal model to be used by the gateway device according to the first embodiment of the present disclosure. In FIG. 4, the horizontal axis represents data X and the vertical axis represents data Y.

With reference to FIG. 4, the storage unit 52 stores therein a detection condition created in advance and based on a plurality of sets that respectively correspond to a plurality of times, e.g., creation times of data. Here, each set is a set of two types of data that correspond to the same creation time and that are included in the transmission messages acquired by the message acquisition unit 55, for example.

Specifically, the storage unit 52 stores therein a normal model M2 created in advance by a server, for example. The normal model M2 is created based on a set of two types of data that have a predetermined correlation, for example. More specifically, the normal model M2 is created based on a set of data of the type to be monitored, and data having a correlation with the data of the type to be monitored.

More specifically, for example, different types of raw data R1 to raw data RN, each including a plurality of time series data, are registered in the server by a user. Here, N is an integer of 2 or greater. In this example, raw data R1 to raw data RN are data acquired during development in a test vehicle of the same type as the vehicle 1, for example.

For example, the server converts raw data R1 to raw data RN into data 1 to data N each including a plurality of time series data at a plurality of common creation times.

More specifically, for example, when the creation times of the time series data included in raw data R1 and the creation times of the time series data included in raw data R2 are not synchronized with each other, the server synchronizes the creation times of the time series data included in raw data R2 with the creation times of the time series data included in raw data R1 by resampling raw data R2.

Likewise, for example, when the creation times of the time series data included in raw data R1 and the creation times of the time series data included in raw data R3 are not synchronized with each other, the server synchronizes the creation times of the time series data included in raw data R3 with the creation times of the time series data included in raw data R1 by resampling raw data R3.

Through similar processes performed also on raw data R4 to raw data RN, the server synchronizes the creation times of the time series data included in raw data R4 to raw data RN with the creation times of the time series data included in the data R1. Thus, raw data R1 to raw data RN each including a plurality of time series data are converted into data 1 to data N each including a plurality of time series data at a plurality of common creation times.

For example, from among data 1 to data N, the server selects data X, Y. Here, X and Y are different from each other, and are each an integer among 1 to N. The selection of data X, Y is performed in a round robin manner, for example.

In FIG. 4, sets of data X and data Y respectively corresponding to a plurality of time series data at a plurality of common creation times are indicated by black dots.

For example, the server calculates a correlation coefficient, based on a plurality of sets of the selected data X and data Y.

For example, when the calculated correlation coefficient is not less than 0.4 and not greater than 0.7, the server determines that there is a correlation between data X and data Y. For example, when the calculated correlation coefficient is greater than 0.7, the server determines that there is a strong correlation between data X and data Y.

When the server has determined that there is a correlation between data X and data Y, or that there is a strong correlation between data X and data Y, the server creates a normal model M2, based on data X and data Y.

Specifically, for example, the server creates a normal model M2 through machine learning, according to an algorithm such as Mahalanobis, Oneclass-SVM (Support Vector Machine), LOF (Local Outlier Factor), Isolation forest, or NN (Nearest-Neighbor).

Meanwhile, when the server has not determined that there is a correlation between data X and data Y, and has not determined that there is a strong correlation between data X and data Y, the server does not create a normal model M2.

For example, the server creates a plurality of normal models M2 and creates model information for each of the created normal models M2. Here, the model information indicates a normal model M2 and a combination of corresponding types of data X and data Y.

For example, the combination of the types of data X and data Y is: engine rotation speed and speed; yaw rate and steer angle; yaw rate and vehicle height; accelerator opening and vehicle body acceleration; or the like.

The plurality of pieces of model information created by the server are collected to form detection condition information, for example, and the detection condition information is registered into the storage unit 52 during production of the vehicle 1.

The detection condition information may be updated. Specifically, for example, the communication processing unit 51 receives, from the server via the in-vehicle communication device 111, detection condition information updated by the server, and updates the detection condition information registered in the storage unit 52 to the received detection condition information.

The server may not necessarily create a plurality of normal models M2, and may create one normal model M2.

[Data Acquisition Unit]

Referring back to FIG. 3, the data acquisition unit 53 acquires a set of two types of data that are included in the transmission message acquired by the message acquisition unit 55 and that correspond to the same time, e.g., reception time.

More specifically, the data acquisition unit 53 acquires, from the storage unit 52, a plurality of pieces of model information included in the detection condition information stored in the storage unit 52.

(Case where Two Types of Data are Included in the Same Transmission Message)

The data acquisition unit 53 acquires a set of two types of data from each transmission message stored in the storage unit 52, for example.

More specifically, for example, based on a plurality of pieces of model information having been acquired, the data acquisition unit 53 acquires, from the storage unit 52, a set of two types of data included in the same transmission message.

Specifically, for example, in a case where data corresponding to the combination of the types indicated by model information is stored in the same transmission message and transmitted in the in-vehicle network 12, the data acquisition unit 53 acquires the two types of data from the same transmission message stored in the storage unit 52.

For example, when a transmission message that includes the two types of data is newly stored in the storage unit 52 by the message acquisition unit 55, the data acquisition unit 53 acquires the two types of data from the newly stored message, and outputs, to the detection unit 54, a set of the acquired two types of data and the combination of the types indicated by the model information. Thus, for example, when two types of data are included in the same transmission message, the data acquisition unit 53 acquires a set of the two types of data having been stored in the transmission message at the same reception time, as a “set of two types of data”.

(Case where Two Types of Data are Respectively Included in Different Transmission Messages)

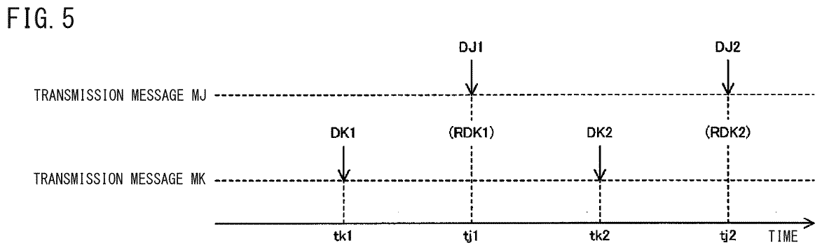

FIG. 5 illustrates timings at which a synchronization process is performed in the gateway device according to the first embodiment of the present disclosure. In FIG. 5 the horizontal axis represents time.

With reference to FIG. 5, for example, based on a plurality of pieces of model information having been acquired, the data acquisition unit 53 acquires, from the storage unit 52, a set of two types of data respectively included in different transmission messages.

Specifically, for example, in a case where pieces of data corresponding to the combination of the types indicated by model information are stored in separate transmission messages and transmitted in the in-vehicle network 12, the data acquisition unit 53 performs the following process.

That is, for example, the data acquisition unit 53 acquires, from the storage unit 52, a plurality of transmission messages MJ that include one type of data DJ, and a plurality of transmission messages MK that include the other type of data DK. Here, the transmission message MJ and the transmission message MK are messages that are transmitted in the same cycle in the in-vehicle network 12, for example.

For example, based on the time stamps attached to the plurality of transmission messages MJ including the one type of data DJ, the data acquisition unit 53 associates reception times with the one type of data DJ.

Specifically, the data acquisition unit 53 associates reception times tj1, tj2 with data DJ1, DJ2, respectively, which are examples of data DJ.

Likewise, for example, based on the time stamps attached to the plurality of transmission messages MK including the other type of data DK, the data acquisition unit 53 associates reception times with the other type of data DK.

Specifically, the data acquisition unit 53 associates reception times tk1, tk2 with data DK1, DK2, respectively, which are examples of data DK.

For example, the data acquisition unit 53 performs resampling of the other type of data DK, based on the reception time associated with the one type of data DJ and the reception time associated with the other type of data DK, thereby performing a synchronization process for synchronizing the reception time of the one type of data DJ and the reception time of the other type of data DK.

For example, when a transmission message MJ including the one type of data DJ is newly stored in the storage unit 52 by the message acquisition unit 55, the data acquisition unit 53 performs the synchronization process.

Specifically, for example, when a transmission message MJ corresponding to the reception time tj2 is newly stored in the storage unit 52 by the message acquisition unit 55, the data acquisition unit 53 resamples data DK including data DK1, DK2, and the like, thereby generating resampled data RDK1, RDK2 that respectively correspond to the reception times tj1, tj2. For example, the data acquisition unit 53, based on the plurality of data DK, interpolates the data DK, thereby generating the resampled data RDK1, RDK2 respectively corresponding to the reception times tj1, tj2.

For example, when the synchronization process is completed, the data acquisition unit 53 acquires the newest set of two types of data from the synchronized two types of data, and outputs, to the detection unit 54, the acquired set of two types of data, and the combination of the types indicated by the model information.

Specifically, for example, the data acquisition unit 53 outputs, to the detection unit 54, the set of data DJ2 and the resampled data RDK2 and the combination of the types indicated by the model information. That is, for example, when two types of data are included in different transmission messages, the data acquisition unit 53 acquires, as a “set of two types of data”, a set of data consisting of: the one type of data DJ2 stored in the transmission message MJ at the reception time tj2; and the resampled data RDK2 of the data DK2 which is stored in the transmission message MK at the reception time tk2 immediately before the reception time tj2, among the transmission messages MK including the other type of data DK. As described above, for example, when the two types of data are included in different transmission messages, the data acquisition unit 53 may not necessarily acquire a set of two types of data stored in transmission messages at the same reception time.

For example, the timing at which the data acquisition unit 53 performs the synchronization process may be a timing at which a transmission message MK including the other type of data DK is newly stored in the storage unit 52 by the message acquisition unit 55.

Specifically, for example, when a transmission message MK corresponding to the reception time tk2 is newly stored in the storage unit 52 by the message acquisition unit 55, the data acquisition unit 53 resamples data DK including data DK1, DK2, and the like, thereby generating resampled data RDK1 corresponding to the reception time tj1. For example, the data acquisition unit 53, based on the plurality of data DK, interpolates the data DK, thereby generating the resampled data RDK1 corresponding to the reception times tj1.

Then, the data acquisition unit 53 outputs, to the detection unit 54, the set of data DJ1 and the resampled data RDK1, and the combination of the types indicated by the model information, for example.

The timing at which the data acquisition unit 53 performs the synchronization process may be a timing at which both a transmission message that includes one type of data and a transmission message that includes the other type of data are newly stored in the storage unit 52 by the message acquisition unit 55, for example.

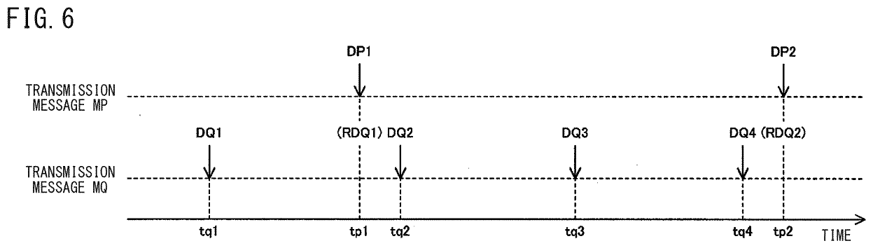

FIG. 6 illustrates timings at which a synchronization process is performed in the gateway device according to the first embodiment of the present disclosure. In FIG. 6, the horizontal axis represents time.

With reference to FIG. 6, a transmission message MP including one type of data DP and a transmission message MQ including the other type of data DQ are messages that are transmitted in different cycles in the in-vehicle network 12, for example.

The data acquisition unit 53 associates reception times tp1, tp2 with data DP1, DP2, respectively, which are examples of data DP.

In addition, the data acquisition unit 53 associates reception times tq1, tq2, tq3, tq4 with data DQ1, DQ2, DQ3, DQ4, respectively, which are examples of data DQ.

For example, when both the transmission messages MP, MQ are newly stored in the storage unit 52 by the message acquisition unit 55, the data acquisition unit 53 performs a synchronization process.

Specifically, for example, at the reception time tp1, the data acquisition unit 53 determines that both the transmission messages MP, MQ have been newly stored in the storage unit 52 by the message acquisition unit 55, and performs the synchronization process.

Likewise, for example, at the reception time tp2, the data acquisition unit 53 determines that both the transmission messages MP, MQ have been newly stored in the storage unit 52 by the message acquisition unit 55, and performs the synchronization process. For example, in the synchronization process at the reception time tp2, the data acquisition unit 53 resamples data DQ including data DQ1 to DQ4, etc., thereby generating resampled data RDQ1, RDQ2 respectively corresponding to the reception times tp1, tp2. For example, the data acquisition unit 53, based on the plurality of data DQ, interpolates the data DQ, thereby generating the resampled data RDQ1, RDQ2 respectively corresponding to the reception times tp1 tp2.

The data acquisition unit 53 outputs, to the detection unit 54, the set of data DP2 and the resampled data RDQ2 and the combination of the types indicated by the model information, for example.

In the synchronization process at the reception time tp2, the data acquisition unit 53 may resample data DP including data DP1, DP2, etc., thereby generating resampled data RDP1 to RDP4 (not shown) respectively corresponding to the reception times tq1 to tq4. Specifically, for example, the data acquisition unit 53, based on the plurality of data DP, interpolates the data DP, thereby generating the resampled data RDP1 to RDP4 respectively corresponding to the reception times tq1 to tq4.

In this case, the data acquisition unit 53 outputs, to the detection unit 54, the set of the resampled data RDP4 and data DQ4 and the combination of the types indicated by the model information. That is, for example, when two types data are included in different transmission messages, the data acquisition unit 53 acquires, as a “set of two types of data”, a set of data consisting of: the one type of data DQ4 stored in the transmission message MQ at the reception time tq4; and the resampled data RDP4 of the data DP2 which is stored in the transmission message MP at the reception time tp2 immediately after the reception time tq4 among the transmission messages MP including the other type of data DP.

At this time, the data acquisition unit 53 may output, to the detection unit 54, the set of the resampled data RDP2 and data DQ2 and the set of the resampled data RDP3 and data DQ3, together. Thus, the number of pieces of data to be used in detection of an unauthorized message can be increased.

Here, the normal model M2 is created based on a plurality of sets of two types of data having the same creation times, while the set of two types of data acquired by the data acquisition unit 53 is the set of two types of data having the same reception time.

In the in-vehicle network 12, transmission of a message is performed at a high speed, and therefore, the creation time of data and the reception time of the data can be considered to be substantially the same. The transmission time of data is also considered to be substantially the same as the creation time of the data and the reception time of the data.

[Detection Unit]

The detection unit 54 calculates an estimated value of monitoring target data that is data of a type to be monitored, in the set of two types of data acquired by the data acquisition unit 53, and determines, by using the calculated estimated value, whether or not a transmission message including the monitoring target data is an unauthorized message.

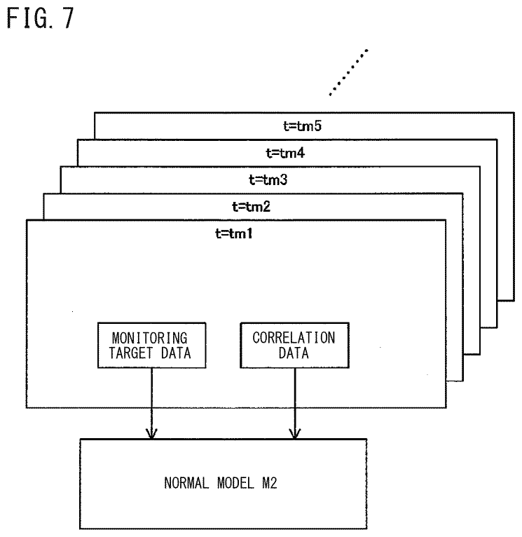

FIG. 7 illustrates a creation process in a learning phase of a normal model according to the first embodiment of the present disclosure.

With reference to FIG. 7, one normal model M2 is created based on monitoring target data and correlation data. There is a correlation between the monitoring target data and the correlation data.

The monitoring target data is data measured by a sensor, and specifically, is data that continuously changes, such as vehicle speed, engine rotation speed, yaw rate, or the like. Hereinafter, the data measured by a sensor is also referred to as sensor data.

The correlation data may be sensor data, or status data indicating a state defined in advance. Here, specifically, the status data indicates a state of an operation section such as a gear, a seat belt, or the like in the vehicle 1, for example.

The server causes the normal model M2 to be learned by using LASSO (Least Absolute Shrinkage and Selection Operator), a regression tree, and the like, based on a learning data set, for example.

Here, the learning data set includes pieces of monitoring target data and pieces of correlation data respectively corresponding to a plurality of identical times, specifically, tm1, tm2, tm3, tm4, tm5, and the like.

More specifically, for example, the server creates a normal model M2 such that when correlation data corresponding to the same time is inputted to the normal model M2, an estimated value that is close to the value of the corresponding monitoring target data is outputted.

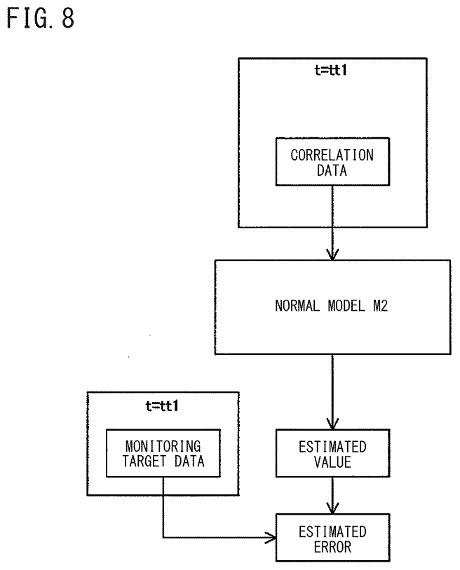

FIG. 8 illustrates a verification process in a test phase of a normal model according to the first embodiment of the present disclosure.

With reference to FIG. 8, the normal model M2 is verified by using a test data set similar to the learning data set.

Specifically, the server creates a distribution of estimated error by using the normal model M2. More specifically, the server inputs, to the normal model M2, correlation data at time tt1 which is a part of the test data set, thereby acquiring an estimated value that is outputted from the normal model M2.

Then the server calculates an estimated error ydiff by using Formula (1) below, for example.

[Math. 1]

ydiff=\sqrt{(y1− [symbol] )}² (1)

In Formula (1), y1 is the value of the corresponding monitoring target data, i.e., the value of the monitoring target data at the time tt1, and y1-hat is the estimated value outputted from the normal model M2.

The server similarly processes correlation data and monitoring target data at times different from the time tt1 in the test data set, thereby creating verification data including an estimated error ydiff at each of the times.

The server creates a distribution of the estimated error ydiff, based on the verification data. This distribution represents the frequency of the estimated error ydiff. In this example, the distribution is unimodal.

When the created distribution is unimodal, the server calculates a mean value μ and a variance σ\hat{ }2 of each estimated error ydiff included in the verification data. Here, “a\hat{ }b” means “a to the power of b”.

The server creates model information Md2 that indicates the normal model M2, the mean value the variance σ\hat{ }2, and the combination of the types of the monitoring target data and the types of the correlation data, for example.

The model information Md2 created by the server is registered in the storage unit 52 as detection condition information when the vehicle 1 is manufactured, for example.

Referring back to FIG. 3, the data acquisition unit 53 acquires the detection condition information from the storage unit 52, and acquires the model information Md2 included in the acquired detection condition information.

When a transmission message including data corresponding to the combination indicated by the model information Md2 is newly stored in the storage unit 52 by the message acquisition unit 55, the data acquisition unit 53 acquires a set of two types of data as described above. Specifically, the data acquisition unit 53 performs the following process.

That is, the data acquisition unit 53, based on the model information Md2, acquires, from the storage unit 52, a set of the monitoring target data and the correlation data included in the same transmission message, and outputs, to the detection unit 54, the acquired set and the combination of the types indicated by the model information Md2.

Meanwhile, for example, when any one of a plurality of transmission messages respectively including data corresponding to the combination indicated by the model information Md2 is newly stored in the storage unit 52 by the message acquisition unit 55, the data acquisition unit 53 performs a synchronization process as described above. Specifically, the data acquisition unit 53 performs the following process.

That is, the data acquisition unit 53, based on the model information Md2, acquires, from the storage unit 52, a set of the monitoring target data and the correlation data respectively included in different transmission messages, and performs a synchronization process on the acquired monitoring target data and correlation data.

When the synchronization process is completed, the data acquisition unit 53 acquires the newest set of the monitoring target data and the correlation data from the synchronized monitoring target data and correlation data, and outputs, to the detection unit 54, the acquired set and the combination of the types indicated by the model information Md2.

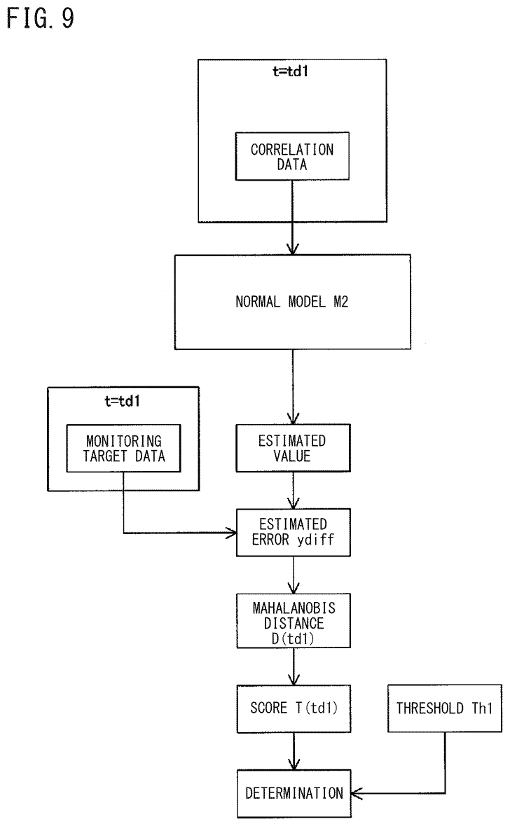

FIG. 9 illustrates an unauthorized message detection process using the normal model according to the first embodiment of the present disclosure.

With reference to FIG. 9, for example, when the detection unit 54 has received, from the data acquisition unit 53, a set of monitoring target data and correlation data at time td1 and the combination of the types indicated by the model information Md2, the detection unit 54 refers to a plurality of pieces of model information included in the detection condition information in the storage unit 52, and acquires, from the storage unit 52, model information Md2 corresponding to the received combination.

For example, based on the set of the monitoring target data and the correlation data acquired by the data acquisition unit 53 and on the normal model M2 included in the model information Md2, the detection unit 54 calculates an estimated error ydiff of the monitoring target data, of the two types of data in the set acquired by the data acquisition unit 53.

More specifically, the detection unit 54 inputs the correlation data received from the data acquisition unit 53 into the normal model M2 included in the model information Md2, thereby acquiring an estimated value outputted from the normal model M2.

Then, the detection unit 54 substitutes the acquired estimated value and the value of the monitoring target data at time td1 for y1-hat and y1 in Formula (1) described above, thereby calculating an estimated error ydiff at time td1. The detection unit 54 stores the calculated estimated error ydiff in the storage unit 52.

For example, based on the calculated estimated error ydiff and on the distribution of the estimated error ydiff created by using the normal model M2, the detection unit 54 calculates an evaluation value regarding authenticity of the monitoring target data.

More specifically, for example, the detection unit 54 substitutes the calculated estimated error ydiff, and the mean value μ and variance σ\hat{ }2 included in the model information Md2 into Formula (2) below, thereby calculating a Mahalanobis distance D(t)\hat{ }2 at time t. For example, the detection unit 54 calculates a Mahalanobis distance D(td1)\hat{ }2 of the estimated error ydiff at time td1. The Mahalanobis distance D(t)\hat{ }2 is an example of an evaluation value regarding the authenticity of the monitoring target data.

$$\begin{matrix}[ Math . 2 ] & \\ {D ( t )}^{2} = \frac{{( yd \text{?} ff - μ )}^{2}}{{σ}^{2}} & ( 2 )\end{matrix}$$

$$\text{?} \text{indicates text missing or illegible when filed}$$

The detection unit 54 may calculate a vector of the estimated error ydiff through multivariate analysis, and calculate the Mahalanobis distance D(t)\hat{ }2 based on Formula (3) below.

[Math. 3]

D(t)²=(X(t)−μx)′Σ⁻¹(X(t)−μx) (3)

In Formula (3), X(t) is the vector of the estimated error ydiff, and μx is an average vector of the estimated error ydiff.

The detection unit 54 stores the calculated Mahalanobis distance D(t)\hat{ }2 in the storage unit 52 in association with the estimated error ydiff.

Based on the calculated estimated error ydiff and an estimated error ydiff calculated in the past, the detection unit 54 determines whether or not the transmission message corresponding to the monitoring target data is an unauthorized message. More specifically, the detection unit 54 calculates the estimated error ydiff, and determines whether or not the transmission message corresponding to the monitoring target data is an unauthorized message, based on the estimated error ydiff and an estimated error ydiff that had just previously been calculated and stored in the storage unit 52.

For example, based on the calculated Mahalanobis distance D(t)\hat{ }2 and a Mahalanobis distance D(t)\hat{ }2 calculated in the past, the detection unit 54 determines whether or not the transmission message corresponding to the monitoring target data is an unauthorized message.

More specifically, the detection unit 54 calculates the Mahalanobis distance D(t)\hat{ }2 at time t, and determines whether or not the transmission message corresponding to the monitoring target data is an unauthorized message, based on this Mahalanobis distance D(t)\hat{ }2 and a Mahalanobis distance D(t−1)\hat{ }2 at time (t−1) that had just previously been calculated and stored in the storage unit 52.

For example, the detection unit 54 determines whether or not the transmission message corresponding to the monitoring target data is an unauthorized message by using an analysis method according to CUSUM (Cumlative Sum) or MCUSUM (Multivariate Cumlative Sum).

More specifically, the detection unit 54 calculates the Mahalanobis distance D(t)\hat{ }2, calculates a score T(t)\hat{ }2 by substituting the calculated Mahalanobis distance D(t)\hat{ }2 into Formula (4) below, and stores the calculated score T(t)\hat{ }2 in the storage unit 52.

[Math. 4]

T(t)²=max{0,T(t−1)²+D(t)²−k} (4)

In Formula (4), the score T(t−1)\hat{ }2 is the score of the Mahalanobis distance D(t−1)\hat{ }2 calculated at time (t−1), i.e., immediately before the Mahalanobis distance D(t)\hat{ }2, and k is a parameter, set in advance, for restricting an outlier from the sum of the score T(t−1)\hat{ }2 and the Mahalanobis distance D(t)\hat{ }2.

For example, when the calculated score T(t)\hat{ }2 is not smaller than a predetermined threshold Th1, the detection unit 54 determines that the transmission message corresponding to the monitoring target data is an unauthorized message.

Meanwhile, for example, when the calculated score T(t)\hat{ }2 is smaller than the predetermined threshold Th1, the detection unit 54 determines that the transmission message corresponding to the monitoring target data is an authorized message.

Upon determining that the transmission message corresponding to the monitoring target data is an unauthorized message, the detection unit 54 performs the following process, for example. That is, the detection unit 54 stores, in the storage unit 52, the ID of the transmission message determined as being unauthorized, the combination of the corresponding types, and the like.

In addition, the detection unit 54 notifies, via the communication processing unit 51, a higher-order device inside or outside the vehicle 1 that an unauthorized message is being transmitted in the transmission line 13.

Although the distribution of the estimated error ydiff created by the server is unimodal, the present disclosure is not limited thereto. The distribution of the estimated error ydiff created by the server may be multimodal.

In this case, the server approximates the distribution of the estimated error ydiff by a Gaussian mixture distribution composed of K Gaussian distributions overlapping each other, for example, and calculates a mean value μ1 to μK and a variance σ1\hat{ }2 to σK\hat{ }2 of each Gaussian distribution, and a mixing proportion C1 to CK of each Gaussian distribution.

For example, the server creates model information Md2 that indicates the normal model M2, the mean value μ1 to μK, the variance σ1\hat{ }2 to σK\hat{ }2, the mixing proportion C1 to CK, and the combination of the types of the monitoring target data and the correlation data.

In this case, the detection unit 54 substitutes the calculated estimated error ydiff, and the mean value μ1 to μk, the variance σ1\hat{ }2 to σK\hat{ } 2, and the mixing proportion C1 to Ck included in the model information Md2, into Formula (5) below, thereby calculating the Mahalanobis distance D(t)\hat{ }2.

$$\begin{matrix}[ Math . 5 ] & \\ {D ( t )}^{2} = {\sum }_{k = 1}^{k} Ck \times \frac{1}{\sqrt{2 π σ {k}^{2}}} \times exp ( B ) & ( 5 )\end{matrix}$$

Here, B in formula (5) is expressed by Formula (6) below.

$$\begin{matrix}[ Math . 6 ] & \\ B = - \frac{{( ydiff - μ k )}^{2}}{2 σ {k}^{2}} & ( 6 )\end{matrix}$$

[Modification 1]

The detection unit 54 calculates the Mahalanobis distance D(t)\hat{ }2, and determines whether or not the transmission message corresponding to the monitoring target data is an unauthorized message by using the analysis method according to CUSUM or MCUSUM. However, the present disclosure is not limited thereto.

For example, the detection unit 54 may calculate a moving average of the estimated error ydiff, based on the calculated estimated error ydiff and an estimated error ydiff calculated in the past, and determine whether or not the transmission message corresponding to the monitoring target data is an unauthorized message, based on the calculated moving average. That is, the detection unit 54 may determine whether or not the transmission message corresponding to the monitoring target data is an unauthorized message by using an analysis method according to EWMA (Exponential Weighted Moving Average) or MEWMA (Multivariate Exponential weighted moving average).

More specifically, the detection unit 54 calculates a vector of the estimated error ydiff through multivariate analysis, and calculates an exponentially weighted moving average A(t) based on Formula (7) below.

[Math. 7]

A(t)=λ×X(t)+(1−λ)×X(t−1) (7)

In Formula (7), X(t) is the vector of the estimated error ydiff, and λ is a moving average coefficient set in advance.

The detection unit 54 calculates the exponentially weighted moving average A(t), and substitutes the calculated exponentially weighted moving average A(t) into Formula (8) below, thereby calculating a score Ta(t)\hat{ }2.

[Math. 8]

Ta(t)²=A(t)′Σ⁻¹A(t) (8)

For example, when the calculated score Ta(t)\hat{ }2 is not smaller than a predetermined threshold Th2, the detection unit 54 determines that the transmission message corresponding to the monitoring target data is an unauthorized message.

Meanwhile, for example, when the calculated score Ta(t)\hat{ }2 is smaller than the predetermined threshold Th2, the detection unit 54 determines that the transmission message corresponding to the monitoring target data is an authorized message.

[Modification 2]

Referring back to FIG. 3, the normal model is created based on sets of two types of data having a predetermined correlation. However, the present disclosure is not limited thereto. The normal model may be created based on sets of three or more types of data having a predetermined correlation, for example.

More specifically, for example, when there are q types of correlation data having a correlation with the monitoring target data, one normal model M4 is created based on the monitoring target data and the q types of correlation data. Here, q is an integer not smaller than 2.

The monitoring target data and each of the q types of correlation data have a correlation. The q types of correlation data may or may not have a correlation with one another.

The server causes the normal model M4 to be learned by using LASSO, a regression tree, and the like, based on a learning data set, for example.

Here, the learning data set includes pieces of monitoring target data and correlation data groups that respectively correspond to a plurality of identical times, specifically, tm1, tm2, tm3, tm4, tm5, and the like.

More specifically, for example, the server creates a normal model M4 such that, when a correlation data group corresponding to the same time is inputted to the normal model M4, an estimated value close to the value of the corresponding monitoring target data is outputted.

The server creates verification data including an estimated error ydiff at each of the times, and creates a distribution of the estimated error ydiff, based on the created verification data.

The server calculates a mean value μ and a variance σ\hat{ }2 of each estimated error diff included in the verification data.

For example, the server creates model information Md4 that indicates the normal model M4, the mean value the variance σ\hat{ }2, and the combination of the types of the monitoring target data and the q types of data in the correlation data group.

For example, the model information Md4 created by the server is registered in the storage unit 52 as detection condition information during production of the vehicle 1.

Referring back to FIG. 3, the data acquisition unit 53 acquires the detection condition information from the storage unit 52, and acquires the model information Md4 included in the acquired detection condition information.

When a transmission message that includes data corresponding to the combination indicated by the model information Md4 has been newly stored in the storage unit 52 by the message acquisition unit 55, the data acquisition unit 53 performs the following process.

That is, the data acquisition unit 53, based on the model information Md4, acquires, from the storage unit 52, a set of the monitoring target data and the correlation data group included in the same transmission message, and outputs, to the detection unit 54, the acquired set and the combination of the types indicated by the model information Md4.

Meanwhile, for example, when any one of a plurality of transmission messages respectively including data corresponding to the combination indicated by the model information Md4 is newly stored in the storage unit 52 by the message acquisition unit 55, the data acquisition unit 53 performs the following process.

That is, the data acquisition unit 53, based on the model information Md4, acquires, from the storage unit 52, a set of the monitoring target data and the correlation data group respectively included in different transmission messages, and performs a synchronization process on the acquired monitoring target data and the correlation data group.

When the synchronization process is completed, the data acquisition unit 53 acquires the newest set of the monitoring target data and the correlation data group from the synchronized monitoring target data and correlation data group, and outputs, to the detection unit 54, the acquired set and the combination of the types indicated by the model information Md4.

For example, when the detection unit 54 has received, from the data acquisition unit 53, a set of the monitoring target data and the correlation data group at time td1 and the combination of the types indicated by the model information Md4, the detection unit 54 refers to a plurality of pieces of model information included in the detection condition information in the storage unit 52, and acquires, from the storage unit 52, the model information Md4 corresponding to the received combination.

For example, based on the set of the monitoring target data and the correlation data group acquired by the data acquisition unit 53 and on the normal model M4 included in the model information Md4, the detection unit 54 calculates an estimated error ydiff of the monitoring target data by using Formula (1) described above, and stores the calculated estimated error ydiff in the storage unit 52.

The detection unit 54 calculates a Mahalanobis distance D(t)\hat{ }2 by substituting the calculated estimated error ydiff, and the mean value μ and variance σ\hat{ }2 included in the model information Md4, into Formula (2) described above, and stores, in the storage unit 52, the calculated Mahalanobis distance D(t)\hat{ }2 in association with the estimated error ydiff.

Then, the detection unit 54 calculates a score T(t)\hat{ }2 by substituting the calculated Mahalanobis distance D(t)\hat{ }2 into Formula (4) described above, and determines, based on the calculated score T(t)\hat{ }2, whether or not the transmission message corresponding to the monitoring target data is an unauthorized message.

The configuration using the normal model M4 realizes more accurate detection of an unauthorized message.

[Modification 3]

In Modification 2, when there are q types of correlation data having a correlation with monitoring target data, one normal model M4 is created based on the monitoring target data and the q types of correlation data. However, the present disclosure is not limited thereto.

For example, when there are two types of correlation data having a correlation with monitoring target data, two detection conditions are created based on the monitoring target data and the two types of correlation data.

Specifically, when the server has determined that, among data 1 to data N at a plurality of common creation times, there is a correlation or a strong correlation between data S and data T and there is a correlation or a strong correlation between data S and data U, the server performs the following process.

That is, irrespective of the magnitude of the correlation coefficient between data T and data U, the server creates a normal model M4 based on data S, T, and creates a normal model M4 based on data S, U.

This configuration reduces the calculation load in creating a normal model, as compared with a configuration in which one normal model M4 is created based on data S, T, U.

[Modification 4]

The gateway device 101 is configured to use one normal model M4 or two normal models M4 based on data S, T, U, but the present disclosure is not limited thereto.

More specifically, for example, a set of multidimensional data can be converted into a set of lower-dimensional data, by using the main component analysis described in PATENT LITERATURE 2 (Japanese Laid-Open Patent Publication No. 2016-57438).

Specifically, for example, the server converts a set of three types of data into a set of two types of data by using the main component analysis, and creates a normal model M4 based on the converted set.

Model information that indicates an eigenvector for converting a set of three types of data into a set of two types of data, a normal model M4 created by the server, and the combination of the types of corresponding data S, data T, and data U, is registered in the storage unit 52 in the gateway device 101.

When the detection unit 54 has received, from the data acquisition unit 53, a set of three types of data and the combination of the types indicated by the model information, the detection unit 54 refers to model information in the storage unit 52, and acquires an eigenvector and a normal model M4 that corresponds to the received combination, from the corresponding model information in the storage unit 52.

The detection unit 54, by using the acquired eigenvector, converts the set of the three types of data received from the data acquisition unit 53 into a set of two types of data. Then, based on the converted set and the normal model M4, the detection unit 54 determines whether or not one, two, or three transmission messages including the three types of data are unauthorized messages.

[Modification 5]

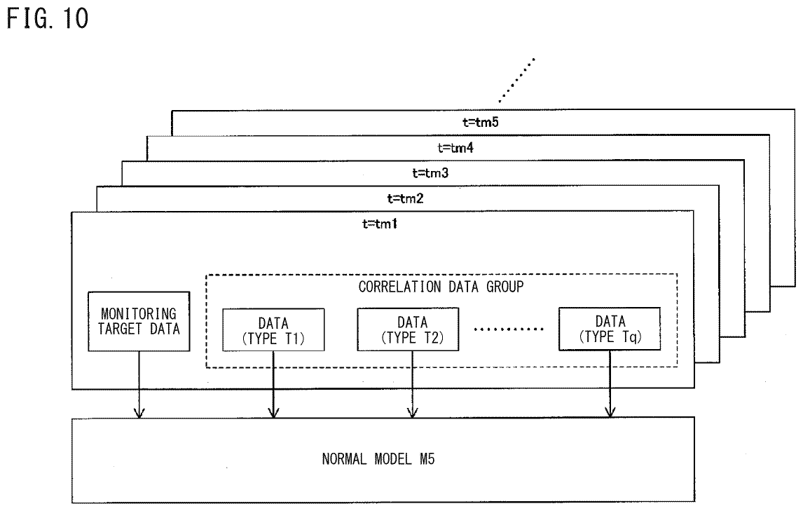

FIG. 10 illustrates a creation process in a learning phase with respect to a modification of the normal model according to the first embodiment of the present disclosure.

With reference to FIG. 10, one normal model M5 is created based on monitoring target data and q types of correlation data. The monitoring target data has a correlation with each of the q types of correlation data. The q types of correlation data may or may not have a correlation with one another.

The monitoring target data is status data indicating a status. Specifically, the monitoring target data is status data indicating a state that discontinuously changes, such as a gear shift position, a seat belt state, or the like.

The q types of data included in the correlation data group may be sensor data, or may be status data.

The server causes the normal model M5 to be learned by using a decision tree, Random Forest, and the like, based on a learning data set, for example.

The learning data set includes pieces of monitoring target data and correlation data groups that respectively correspond to a plurality of identical times, specifically, times tm1, tm2, tm3, tm4, tm5, and the like.

More specifically, for example, the server creates a normal model M5 such that, when a correlation data group corresponding to the same time is inputted to the normal model M5, an estimated value that matches the value of the corresponding monitoring target data is outputted.

For example, the server creates model information Md5 that indicates the normal model M5 and the combination of the types of the monitoring target data and the q types of data in the correlation data group.

The model information Md5 created by the server is registered in the storage unit 52 as detection condition information during production of the vehicle 1, for example.

Referring back to FIG. 3, the data acquisition unit 53 acquires the detection condition information from the storage unit 52, and acquires the model information Md5 included in the acquired detection condition information.

When a transmission message that includes data corresponding to the combination indicated by the model information Md5 is newly stored in the storage unit 52 by the message acquisition unit 55, the data acquisition unit 53 performs the following process.

That is, the data acquisition unit 53, based on the model information Md5, acquires, from the storage unit 52, a set of the monitoring target data and the correlation data group included in the same transmission message, and outputs, to the detection unit 54, the acquired set and the combination of the types indicated by the model information Md5.

Meanwhile, for example, when any one of a plurality of transmission messages respectively including data corresponding to the combination indicated by the model information Md5 is newly stored in the storage unit 52 by the message acquisition unit 55, the data acquisition unit 53 performs the following process.

That is, the data acquisition unit 53, based on the model information Md5, acquires, from the storage unit 52, a set of the monitoring target data and the correlation data group respectively included in different transmission messages, and performs a synchronization process on the acquired monitoring target data and correlation data group.

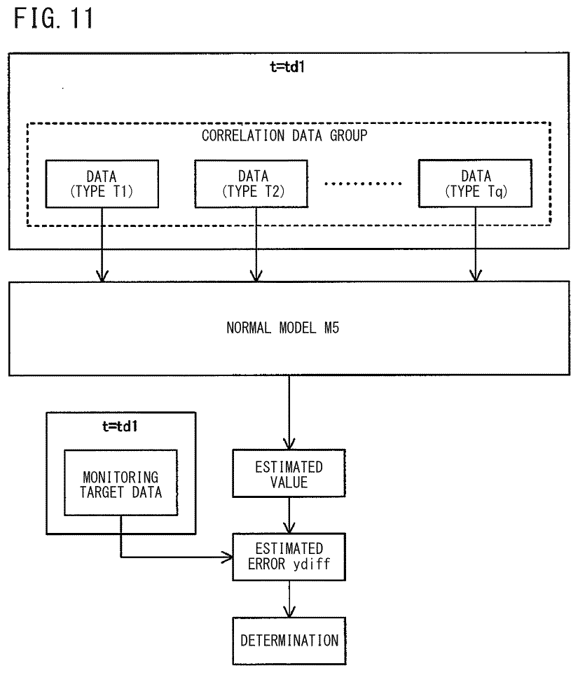

When the synchronization process is completed, the data acquisition unit 53 acquires the newest set of monitoring target data and correlation data group from the synchronized monitoring target data and correlation data group, and outputs, to the detection unit 54, the acquired set and the combination of the types indicated by the model information Md5. FIG. 11 illustrates an unauthorized message detection process using a modification of the normal model according to the first embodiment of the present disclosure.

With reference to FIG. 11, for example, when the detection unit 54 has received, from the data acquisition unit 53, a set of monitoring target data and a correlation data group at time td1, and the combination of the types indicated by the model information Md5, the detection unit 54 refers to a plurality of pieces of model information included in the detection condition information in the storage unit 52, and acquires, from the storage unit 52, model information Md5 corresponding to the received combination.

For example, the detection unit 54 estimates a value of the monitoring target data, based on the correlation data group acquired by the data acquisition unit 53 and on the normal model M5 included in the model information Md2.

More specifically, the detection unit 54 inputs the correlation data group received from the data acquisition unit 53 into the normal model M5 included in the model information Md5, thereby acquiring an estimated value, of the monitoring target data, outputted from the normal model M5.

Then, the detection unit 54 calculates an estimated error ydiff by comparing the acquired estimated value with the value of the monitoring target data at time td1.

More specifically, for example, the detection unit 54 compares the acquired estimated value with the value of the monitoring target data at time td1, and calculates an estimated error ydiff being “1” when these values match, and an estimated error ydiff being “0” when these values do not match.

When the detection unit 54 has calculated the estimated error ydiff, the detection unit 54 stores the calculated estimated error ydiff in the storage unit 52.

Based on the calculated estimated error ydiff and the estimated error ydiff calculated in the past, the detection unit 54 determines whether or not the transmission message corresponding to the monitoring target data is an unauthorized message. More specifically, the detection unit 54 calculates the estimated error ydiff, and determines whether or not the transmission message corresponding to the monitoring target data is an unauthorized message, based on the estimated error ydiff and an estimated error ydiff that had just previously been calculated and stored in the storage unit 52.

For example, when the newly calculated estimated error ydiff and the estimated error ydiff that had just previously been calculated and stored in the storage unit 52 are “0”, the detection unit 54 determines that the transmission message corresponding to the monitoring target data is an unauthorized message.

On the other hand, when at least one of the newly calculated estimated error ydiff and the estimated error ydiff that had just previously been calculated and stored in the storage unit 52 is “1”, the detection unit 54 determines that the transmission message corresponding to the monitoring target data is an authorized message.

[Operation Flow]

Each device in the in-vehicle communication system according to the embodiment of the present disclosure includes a computer that includes a memory. An arithmetic processing unit such as a CPU in the computer reads out, from the memory, a program including a part or all of steps in the flow chart and sequence shown below, and executes the program. Programs of the plurality of devices can each be installed from outside. The programs of the plurality of devices are each distributed in a state of being stored in a storage medium.

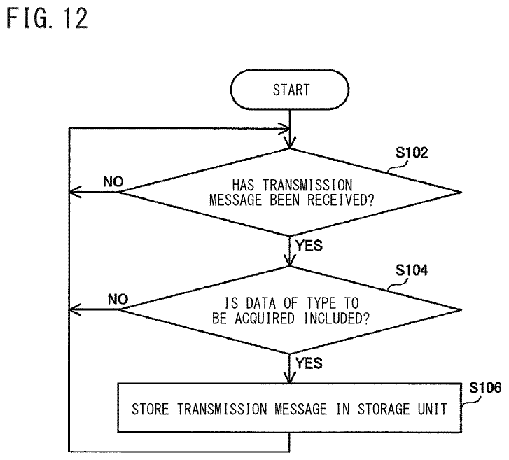

FIG. 12 is a flowchart of a procedure of operation performed when the gateway device according to the first embodiment of the present disclosure receives a transmission message.

With reference to FIG. 12, a situation in which model information Md2 indicates a normal model M2, and the combination of the types of data X as monitoring target data and data Y as correlation data, is assumed.

First, for example, the gateway device 101 waits for a transmission message from a control device 122 (NO in step S102).

Upon receiving a transmission message from a control device 122 (YES in step S102), the gateway device 101 confirms whether or not data of a type to be acquired is included in the received transmission message (step S104).

Next, when the data of the type to be acquired is included in the received transmission message (YES in step S104), the gateway device 101 stores the received transmission message in the storage unit 52 (step S106). At this time, the gateway device 101 attaches a time stamp to the transmission message.

Next, when the gateway device 101 stores the received transmission message in the storage unit 52 (step S106), or when the data of the type to be acquired is not included in the received transmission message (NO in step S104), the gateway device 101 performs a relay process for the received transmission message, and then waits for a new transmission message from a control device 122 (NO in step S102).

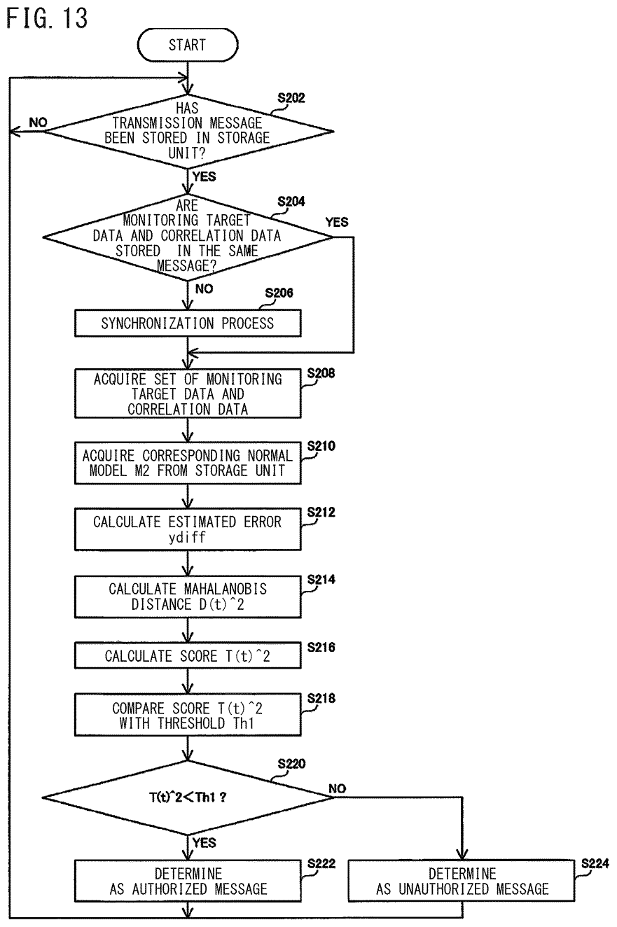

FIG. 13 is a flowchart of a procedure of operation performed when the gateway device according to the first embodiment of the present disclosure has stored a received transmission message in the storage unit.

With reference to FIG. 13, a situation in which model information Md2 indicates a normal model M2 and the combination of the types of data X as monitoring target data and data Y as correlation data, is assumed.

First, the gateway device 101 waits until a transmission message is stored in the storage unit 52 (NO in step S202).

Then, when the transmission message has been stored in the storage unit 52 (YES in step S202), the gateway device 101 confirms whether or not monitoring target data and correlation data corresponding to the combination of the two types indicated by the model information Md2 are stored in the transmission message, i.e., in the same transmission message (step S204).

Next, when monitoring target data and correlation data corresponding to the combination of the two types indicated by the model information Md2 are not included in the same transmission message, i.e., are included in separate transmission messages (NO in step S204), the gateway device 101 performs a synchronization process on the monitoring target data and the correlation data indicated by the model information Md2 (step S206).

Next, the gateway device 101 acquires, from the transmission message, a set of the monitoring target data and the correlation data indicated by the model information Md2, or acquires, from the monitoring target data and the correlation data having been subjected to the synchronization process, the newest set of the monitoring target data and the correlation data indicated by the model information Md2 (step S208).

Next, the gateway device 101 acquires, from the storage unit 52, a normal model M2 that corresponds to the acquired set of the monitoring target data and the correlation data (step S210).

Next, the gateway device 101 calculates an estimated error ydiff of the monitoring target data, based on the acquired set of the monitoring target data and the correlation data and on the normal model M2 (step S212).

Next, the gateway device 101 calculates a Mahalanobis distance D(t)\hat{ }2 (step S214), based on the calculated estimated error ydiff and on a distribution, of the estimated error ydiff, created by using the normal model M2.

Next, the gateway device 101 calculates a score T(t)\hat{ }2, based on the calculated Mahalanobis distance D(t)\hat{ }2 and on a Mahalanobis distance D(t−1)\hat{ }2 that had just previously calculated and stored in the storage unit 52 (step S216).

Next, the gateway device 101 compares the calculated score T(t)\hat{ }2 with a predetermined threshold Th1 (step S218).

When the score T(t)\hat{ }2 is smaller than the threshold Th1, the gateway device 101 determines that the transmission message corresponding to the monitoring target data is an authorized message (step S222).

When the score T(t)\hat{ }2 is not smaller than the threshold Th1, the gateway device 101 determines that the transmission message corresponding to the monitoring target data is an unauthorized message (step S224).

Next, the gateway device 101 waits until a new transmission message is stored in the storage unit 52 (NO in step S202).

In the operation flow described above, a situation in which the model information Md2 indicating the normal model M2 and the combination of the types of corresponding monitoring target data and correlation data is used, is assumed. However, the present disclosure is not limited thereto. For example, the model information Md4 indicating the normal model M4 and the combination of the monitoring target data and the q types of correlation data may be used. In this case, the gateway device 101 acquires sets of the monitoring target data and the q types of correlation data in the above step S208, and acquires the corresponding normal model M4 from the storage unit 52 in the above step S210.

In the gateway device according to the first embodiment of the present disclosure, the message acquisition unit 55 is configured to acquire a plurality of transmission messages in the in-vehicle network 12. However, the present disclosure is not limited thereto. The message acquisition unit 55 may be configured to acquire one transmission message in the in-vehicle network 12. For example, when data corresponding to the combination of two types indicated by model information is included in the one transmission message, it is possible to determine whether or not the transmission message is an unauthorized message.

In the in-vehicle communication system according to the first embodiment of the present disclosure, the gateway device 101 is configured to detect an unauthorized message in the in-vehicle network 12. However, the present disclosure is not limited thereto. In the in-vehicle communication system 301, a detection device different from the gateway device 101 may detect an unauthorized message in the in-vehicle network 12.

In the gateway device according to the first embodiment of the present disclosure, the data acquisition unit 53 is configured to acquire a set of a plurality of types of data corresponding to the same reception time. However, the present disclosure is not limited thereto. The data acquisition unit 53 may acquire a set of a plurality of types of data corresponding to the same transmission time, the same creation time, or the like, instead of the reception time. Specifically, for example, in a case where a control device 122 stores, in a transmission message, the creation time of data or the transmission time of the transmission message, and transmits the transmission message, the data acquisition unit 53 can acquire a set of a plurality of types of data corresponding to the same transmission time or the same creation time.

In the gateway device according to the first embodiment of the present disclosure, the detection unit 54 is configured to use a transmission message exchanged between control devices 122 as a detection target for an unauthorized message. However, the present disclosure is not limited thereto. The detection unit 54 may use a transmission message exchanged between a control device 122 and an in-vehicle communication device 111, and a transmission message exchanged between in-vehicle communication devices 111 as detection targets for an unauthorized message.

In the gateway device according to the first embodiment of the present disclosure, the normal model is created based on sets of a plurality of types of data that have a predetermined correlation. However, the present disclosure is not limited thereto. The normal model may be created based on sets of a plurality of types of data that do not have a predetermined correlation.

In the gateway device according to the first embodiment of the present disclosure, the data acquisition unit 53 is configured to acquire a plurality of types of data from transmission messages stored in the storage unit 52 by the message acquisition unit 55, and resample the acquired data. However, the present disclosure is not limited thereto. For example, when the reception times of the transmission messages are close to each other, the data acquisition unit 53 may directly receive the transmission messages from the message acquisition unit 55, acquire a plurality of types of data from the received transmission messages, and use the acquired data in the detection without resampling the acquired data.

Meanwhile, a technology capable of more accurately detecting an unauthorized message in an in-vehicle network has been desired.

For example, a so-called bus monopolizing type attack model is assumed as an attack model of an unauthorized in-vehicle device. This attack model causes an authorized message from an authorized in-vehicle device to stop, and transmits an unauthorized message in the same transmission cycle as an authorized message. In the bus monopolizing type attack model, if an unauthorized in-vehicle device learns, through machine learning, the transmission time of an authorized message from an authorized in-vehicle device, and transmits an unauthorized message such that a standard deviation of the transmission interval becomes substantially equal to that of the authorized message, it is difficult to detect this unauthorized message.

The technology described in PATENT LITERATURE 1 can detect the unauthorized message generated by the bus monopolizing type attack model. However, in the technology described in PATENT LITERATURE 1, if monitoring target data included in an authorized message has suddenly changed, the authorized message may be erroneously detected as an unauthorized message. Therefore, further improvement of the detection performance is desired.

Meanwhile, the gateway device 101 according to the first embodiment of the present disclosure detects an unauthorized message in the in-vehicle network 12 mounted in the vehicle 1. The message acquisition unit 55 acquires one or a plurality of transmission messages in the in-vehicle network 12. The data acquisition unit 53 acquires a set of a plurality of types of data that are included in the transmission messages acquired by the message acquisition unit 55 and correspond to the same time. The storage unit 52 stores therein a detection condition created in advance and based on a plurality of sets that respectively correspond to a plurality of times. Based on the set acquired by the data acquisition unit 53 and on the detection condition, the detection unit 54 calculates an estimated error of monitoring target data in the set. Based on the calculated estimated error and an estimated error calculated in the past, the detection unit 54 determines whether or not the transmission message corresponding to the monitoring target data is an unauthorized message.

The detection method according to the first embodiment of the present disclosure is a detection method used in a gateway device 101 that includes the storage unit 52 and detects an unauthorized message in the in-vehicle network 12 mounted in the vehicle 1. The storage unit 52 stores therein a detection condition created in advance and based on a plurality of sets that respectively correspond to a plurality of times. In this detection method, first, the gateway device 101 acquires one or a plurality of transmission messages in the in-vehicle network 12. Next, the gateway device 101 acquires a set of a plurality of types of data that are included in the acquired transmission messages and correspond to the same time. Next, based on the acquired set and the detection condition, the gateway device 101 calculates an estimated error of monitoring target data in the set. Next, based on the calculated estimated error and an estimated error calculated in the past, the gateway device 101 determines whether or not the transmission message corresponding to the monitoring target data is an unauthorized message.

In the above configuration and method, an estimated error of monitoring target data in a set of a plurality of types of data is calculated, and whether or not a transmission message corresponding to the monitoring target data is an unauthorized message is determined based on the calculated estimated error and an estimated error calculated in the past. Therefore, when compared with the conventional technology in which whether or not a transmission message is an unauthorized message is determined based on authenticity of a current estimated error, for example, the technology of the present disclosure can reduce an adverse effect of a sudden change of data on the determination result, whereby the detection performance can be improved.

Therefore, in the detection device and the detection method according to the first embodiment of the present disclosure, an unauthorized message in the in-vehicle network can be more accurately detected. More specifically, according to the configuration and the method, an unauthorized message can be detected by using, for example, a cumulative value of the estimated error in the bus monopolizing type attack model, and therefore, the detection performance can be improved as compared with the technology described in PATENT LITERATURE 1. Moreover, according to the above configuration and method, also in a so-called a bus sharing type attack model in which an unauthorized message is transmitted without stopping an authorized message from an authorized in-vehicle device, the unauthorized message can be detected by using the cumulative value of the estimated error, for example. Therefore, when the risk of an authorized message being determined as an unauthorized message is acceptable to some extent, the detection performance can be improved as compared with the technology described in PATENT LITERATURE 1.

Next, another embodiment of the present disclosure will be described with reference to the drawings. In the drawings, the same or corresponding parts are denoted by the same reference signs, and descriptions thereof are not repeated.

### Second Embodiment

The present embodiment relates to a gateway device in which unauthorized message detection based on a transmission interval of a transmission message is incorporated, as compared with the gateway device according to the first embodiment. The gateway device according to the present embodiment is the same as that of the first embodiment, except for the contents described below.

[Configuration and Basic Operation]

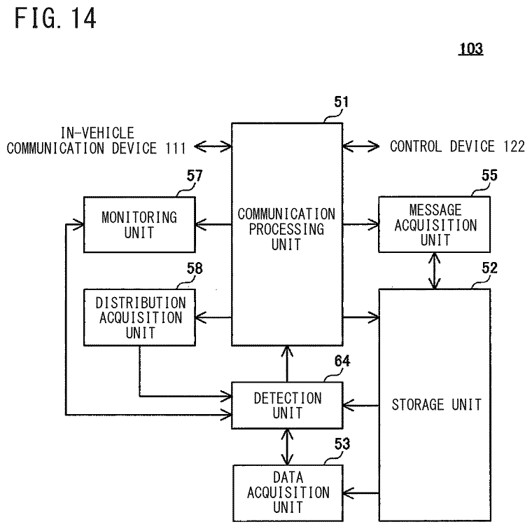

FIG. 14 shows a configuration of a gateway device in an in-vehicle communication system according to the second embodiment of the present disclosure.

With reference to FIG. 14, a gateway device 103 includes a communication processing unit 51, a storage unit 52, a data acquisition unit 53, a message acquisition unit 55, a monitoring unit 57, a distribution acquisition unit 58, and a detection unit 64. The detection unit 64 is an example of a calculation unit, and an example of a determination unit.

Operations of the communication processing unit 51, the storage unit 52, the data acquisition unit 53, and the message acquisition unit 55 in the gateway device 103 are the same as those of the communication processing unit 51, the storage unit 52, the data acquisition unit 53, and the message acquisition unit 55 of the gateway device 101 shown in FIG. 3. The monitoring unit 57, the distribution acquisition unit 58, and the detection unit 64 are realized by a processor such as a CPU or a DSP, for example.

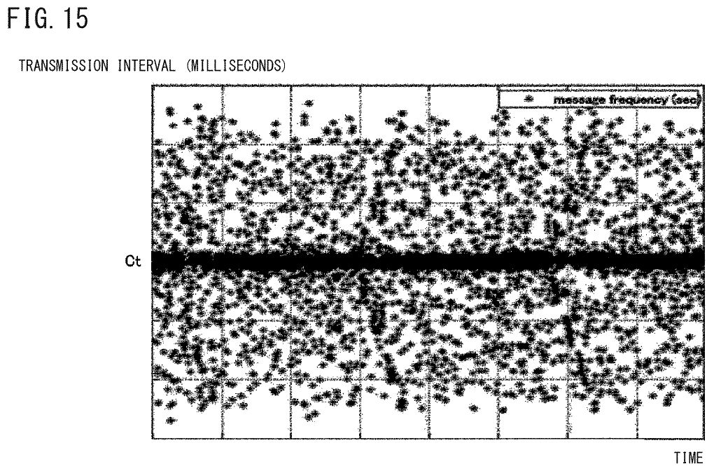

FIG. 15 shows an example of temporal change in a transmission interval of a periodic message to be monitored in the in-vehicle communication system according to the second embodiment of the present disclosure. In FIG. 15, the vertical axis represents transmission interval and the horizontal axis represents time.

With reference to FIG. 15, the transmission interval is an interval of timing at which a certain periodic message to be monitored is transmitted in a transmission line 13, for example. Hereinafter, the periodic message to be monitored is also referred to as a target message.

As shown in FIG. 15, the transmission interval of the target message is not constant and is varied. This is because arbitration is performed when the target message is transmitted or delay variation occurs in internal processing due to clock deviation.

Here, the arbitration is described. Each message is assigned a priority according to an ID, for example. For example, when transmission times of a plurality of messages overlap each other, arbitration is performed in the in-vehicle network 12 such that a message having a higher priority is transmitted, in the transmission line 13, in preference to a message having a lower priority. This arbitration causes variation in the transmission interval.

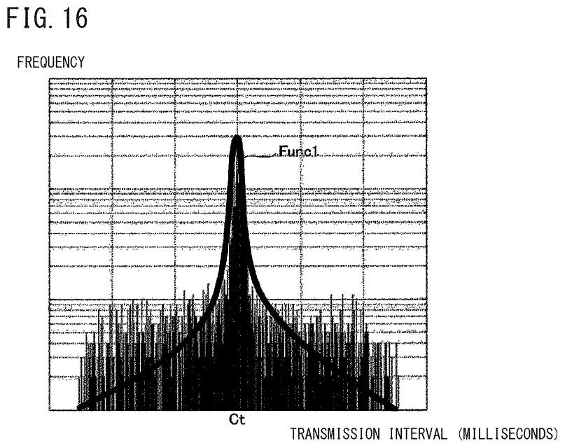

FIG. 16 shows an example of a frequency distribution of target message transmission intervals in the in-vehicle communication system according to the second embodiment of the present disclosure. In FIG. 16, the vertical axis represents frequency and the horizontal axis represents transmission interval.

With reference to FIG. 16, the frequency distribution of transmission intervals is substantially symmetric with respect to Ct milliseconds. The frequency distribution of transmission intervals can be approximated by a predetermined model function Func1, for example.

Referring back to FIG. 14, the monitoring unit 57 monitors transmission messages in the in-vehicle network 12, for example. More specifically, for example, the monitoring unit 57 monitors the transmission message relay process in the communication processing unit 51, and measures the transmission interval of the target message, based on the monitoring result.

Specifically, for example, one ID indicating the target message is registered in the monitoring unit 57. Hereinafter, the registered ID indicating the target message is also referred to as a registered ID. A plurality of registered IDs may be stored in the monitoring unit 57.

For example, when the communication processing unit 51 has received a transmission message, the monitoring unit 57 confirms an ID included in the transmission message received by the communication processing unit 51. When the confirmed ID matches the registered ID, the monitoring unit 57 maintains, as a measurement reference, a reception time t1 of the transmission message, i.e., the target message, received by the communication processing unit 51, for example.

Then, when a new target message including the registered ID has been received in the communication processing unit 51, the monitoring unit 57 maintains a reception time t2 of the newly received target message, and performs the following process.

That is, the monitoring unit 57 calculates a transmission interval of the target message by subtracting the reception time t1 from the reception time t2, and outputs the calculated transmission interval and the registered ID to the detection unit 64.

The distribution acquisition unit 58 acquires a distribution of transmission intervals of transmission messages, for example. Specifically, the distribution acquisition unit 58 acquires distribution information indicating a distribution of transmission intervals created in advance by another device, specifically, a server, for example.

More specifically, for example, the server acquires a plurality of transmission intervals of the target message. These transmission intervals are measured in a test vehicle of the same type as the vehicle 1, for example. The server may acquire transmission intervals measured in the vehicle 1.

For example, as the model function Func1, the server uses a probability density function p of normal distribution that is shown in Formula (9) below and has x as a variable. Hereinafter, the probability density function p is also referred to as a normal distribution function.

$$\begin{matrix}[ Math . 9 ] & \\ p ( x \vert \overline{x} , {σ}^{2} ) = \frac{1}{\sqrt{2 π {σ}^{2}}} exp \{ - \frac{{( x - \overline{x} )}^{2}}{2 {σ}^{2}} \} & ( 9 )\end{matrix}$$

In Formula (9), x-bar and σ\hat{ }2 are parameters and are respectively a mean value and a variance of a plurality of transmission intervals. The x-bar and σ\hat{ }2 are respectively calculated by Formulae (10) and (11) below.

$$\begin{matrix}[ Math . 10 ] & \\ \overline{x} = \frac{1}{t} {\sum }_{t = 1}^{t} {x}_{i} & ( 10 )\end{matrix}$$

$$\begin{matrix}[ Math . 11 ] & \\ {σ}^{2} = \frac{1}{t} {\sum }_{i = 1}^{t} {( {x}_{i} - \overline{x} )}^{2} & ( 11 )\end{matrix}$$

In Formulae (10) and (11), t is the number of samples of transmission intervals, and xi denotes the i-th transmission interval. The server transmits, to the vehicle 1, distribution information including x-bar and σ\hat{ }2 at a predetermined distribution timing, for example.

Upon receiving the distribution information from the server via an in-vehicle communication device 111 and the communication processing unit 51, the distribution acquisition unit 58 creates a model function Func1 represented by Formula (9), based on the received distribution information, and outputs the created model function Func1 to the detection unit 64.

In the gateway device 101, the distribution acquisition unit 58 receives the distribution information from the server via an in-vehicle communication device 111 and the communication processing unit 51, and outputs the distribution information to the detection unit 64. However, the present disclosure is not limited thereto. For example, the gateway device 101 may have a nonvolatile memory, and the distribution acquisition unit 58 may acquire, from the nonvolatile memory in which distribution information is written via the port 112 by the maintenance terminal device, the distribution information, and output the distribution information to the detection unit 64.

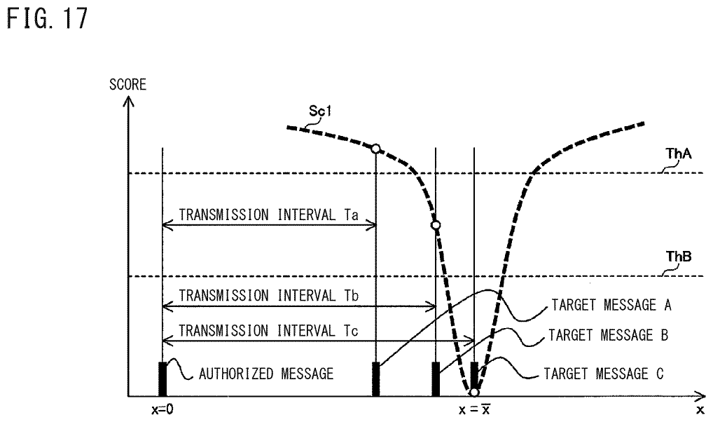

FIG. 17 shows an example of unauthorized message detection by the detection unit in the gateway device according to the second embodiment of the present disclosure. In FIG. 17, the vertical axis represents score and the horizontal axis represents variable x.

With reference to FIG. 17, the detection unit 64 detects an unauthorized message, based on a monitoring result by the monitoring unit 57 and on a distribution of transmission intervals acquired by the distribution acquisition unit 58, for example.

Specifically, for example, the detection unit 64 determines whether or not to treat the transmission message as an unauthorized message, based on transmission intervals measured by the monitoring unit 57, distribution information indicating the distribution of the transmission intervals, and a predetermined threshold. Here, a threshold ThB is registered in the detection unit 64.

In other words, the detection unit 64 detects an unauthorized message, based on a position, in the distribution, of a transmission interval measured by the monitoring unit 57, for example.

Upon receiving the model function Func1 from the distribution acquisition unit 58, the detection unit 64 creates a score function Sc1 by transforming the received model function Func1. More specifically, for example, the detection unit 64 creates −log(Func1) as the score function Sc1. Here, “log(c)” means a common logarithm of c.

In FIG. 17, the score function Sc1 is expressed such that the measurement reference time corresponds to x=0. Therefore, the horizontal axis shown in FIG. 17 represents transmission interval. The score function Sc1 indicates a minimum value when the variable x is the mean value, i.e., x-bar.

The detection unit 64 calculates a score by substituting the transmission interval received from the monitoring unit 57, into the variable x in the score function Sc1.

When the calculated score is not greater than the threshold ThB, for example, the detection unit 64 determines that the target message transmitted this time should not be treated as an unauthorized message, i.e., determines that the target message is an authorized message or a message having a pseudo transmission interval. Hereinafter, the message having a pseudo transmission interval is also referred to as a pseudo message.

Specifically, when the detection unit 64 has received a transmission interval Tc shown in FIG. 17 from the monitoring unit 57, the detection unit 64 determines that a target message C transmitted this time is an authorized message or a pseudo message.

The reason is as follows. That is, when the target message is an authorized message or a pseudo message, for example, even if variation due to arbitration, delay of internal processing, or the like is included, there is a high possibility that the transmission interval is positioned in the vicinity of the center of the frequency distribution shown in FIG. 16.

Meanwhile, when the calculated score is greater than the threshold ThB, the detection unit 64 determines that the target message transmitted this time is an unauthorized message. Specifically, when the detection unit 64 has received a transmission interval Ta shown in FIG. 17 from the monitoring unit 57, the detection unit 64 determines that a target message A transmitted this time is an unauthorized message. Likewise, when the detection unit 64 has received a transmission interval Tb from the monitoring unit 57, the detection unit 64 determines that a target message B transmitted this time is an unauthorized message.

The reason is as follows. That is, when the target message is an unauthorized message, for example, there is a high possibility that the target message is not transmitted in accordance with a predetermined rule.

When the level of security is to be lowered, the threshold registered in the detection unit 64 is changed to ThA that is greater than ThB. Thus, for example, as in the case of the target message B corresponding to the transmission interval Tb, a transmission message determined as an unauthorized message by the detection unit 64 is determined as an authorized message or a pseudo message after the threshold has been changed.

The detection unit 64 notifies the monitoring unit 57 of the determination result based on the transmission interval received from the monitoring unit 57.

The monitoring unit 57 uses, as a measurement reference for transmission interval, the reception timing of the transmission message determined as an authorized message or a pseudo message, for example.

More specifically, when the determination result notified from the detection unit 64 indicates that the target message transmitted this time is an authorized message or a pseudo message, the monitoring unit 57 uses the reception time t2 as a new measurement reference for transmission interval.

Then, when a new target message including the registered ID has been received in the communication processing unit 51, the monitoring unit 57 maintains a reception time t3 of the newly received target message, and performs the following process.

That is, the monitoring unit 57 calculates a new transmission interval of the target message by subtracting the reception time t2 from the reception time t3, and outputs the calculated transmission interval to the detection unit 64.

Meanwhile, when the determination result notified from the detection unit 64 indicates that the target message transmitted this time is an unauthorized message, the monitoring unit 57 maintains the reception time t1 as the measurement reference.

Then, when a new target message including the registered ID has been received in the communication processing unit 51, the monitoring unit 57 maintains the reception time t3 of the newly received target message, and performs the following process.

That is, the monitoring unit 57 calculates a new transmission interval of the target message by subtracting the reception time t1 from the reception time t3, and outputs the calculated transmission interval to the detection unit 64.

For example, with respect to a target message that has been determined as not to be treated as an unauthorized message, based on the distribution of the transmission intervals measured by the monitoring unit 57, the detection unit 64 calculates an estimated error ydiff of the data stored in the target message, and determines whether or not the target message is an unauthorized message, based on the calculated estimated error ydiff and an estimated error ydiff calculated in the past.

More specifically, when the detection unit 64 has determined that the target message C transmitted this time is an authorized message or a pseudo message, the detection unit 64 outputs, to the data acquisition unit 53, the registered ID received from the monitoring unit 57.

Upon receiving the registered ID from the detection unit 64, the data acquisition unit 53 acquires the newest transmission message having the received registered ID, i.e., the newest target message, from among a plurality of transmission messages stored in the storage unit 52.

In this example, one piece of data is stored in the target message. The data acquisition unit 53 recognizes the type of the one piece of data stored in the acquired newest target message. In the target message, two or more pieces of data may be included. Hereinafter, the type of the one piece of data included in the newest target message acquired by the data acquisition unit 53 is also referred to as a target type.

The data acquisition unit 53 refers to a plurality of pieces of model information included in the detection condition information stored in the storage unit 52, and acquires, from the storage unit 52, model information that indicates the recognized target type, from among the plurality of pieces of model information referred to.

The data acquisition unit 53, based on the acquired model information, specifies a type of data to be combined with the target type. Hereinafter, the type of data to be combined with the target type is also referred to as a counterpart type. Hereinafter, it is assumed that data of the target type is monitoring target data, and data of the counterpart type is correlation data.

For example, the data acquisition unit 53 acquires, from the storage unit 52, a plurality of target messages that include data of the target type, and a plurality of transmission messages that include data of the counterpart type, and performs a synchronization process for synchronizing the reception time of the target-type data and the reception time of the counterpart-type data, based on the acquired transmission messages.

When the synchronization process is completed, the data acquisition unit 53 acquires a set of the newest two types of data from the synchronized two types of data, and outputs, to the detection unit 64, the acquired set of the two types of data and the combination of the types indicated by the model information.

Upon receiving the set of the two types of data and the combination of the types indicated by the model information from the data acquisition unit 53, the detection unit 64 refers to a plurality of pieces of model information included in the detection condition information in the storage unit 52, and acquires a normal model M2 corresponding to the received combination from the corresponding model information in the storage unit 52.

The detection unit 64 calculates an estimated error ydiff of the target-type data, based on a set of the target-type data and the counterpart-type data acquired by the data acquisition unit 53 and on the normal model M2 included in the model information Md2.

The detection unit 54 substitutes the calculated estimated error ydiff, and the mean value μ and the variance σ\hat{ }2 included in the model information Md2, into the above Formula (2), thereby calculating a Mahalanobis distance D(t)\hat{ }2.

When the detection unit 54 has calculated the Mahalanobis distance D(t)\hat{ }2, the detection unit 54 calculates a score T(t)\hat{ }2 by substituting the calculated Mahalanobis distance D(t)\hat{ }2 into the above Formula (4), and determines whether or not the target message is an unauthorized message, based on the calculated score T(t)\hat{ }2.

Upon determining that the target message is an unauthorized message, the detection unit 64 performs the following process, for example. That is, the detection unit 64 stores, in the storage unit 52, the registered ID, the ID of the transmission message including the counterpart-type data, the combination of the corresponding types, and the like.

In addition, the detection unit 64 notifies, via the communication processing unit 51, a higher-order device inside or outside the vehicle 1 that an unauthorized message is being transmitted in the transmission line 13.

[Operation Flow]

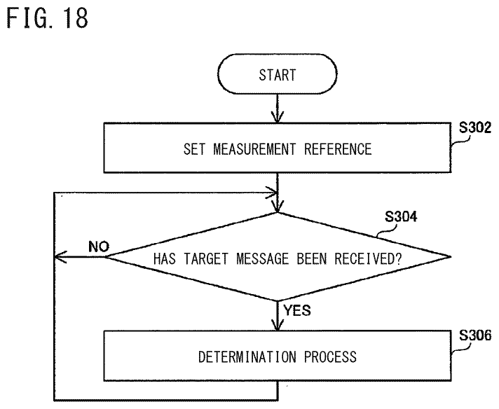

FIG. 18 is a flowchart of a procedure of operation performed when the gateway device according to the second embodiment of the present disclosure receives a target message.

With reference to FIG. 18, first, the gateway device 103 receives a first target message, and sets the reception time of the target message as a measurement reference (step S302).

Next, the gateway device 103 waits for a target message (NO in step S304).

Then, upon receiving the target message (YES in step S304), the gateway device 103 performs a determination process of determining whether or not the received target message should be treated as an unauthorized message (step S306).

Next, the gateway device 103 waits for a new target message (NO in step S306).

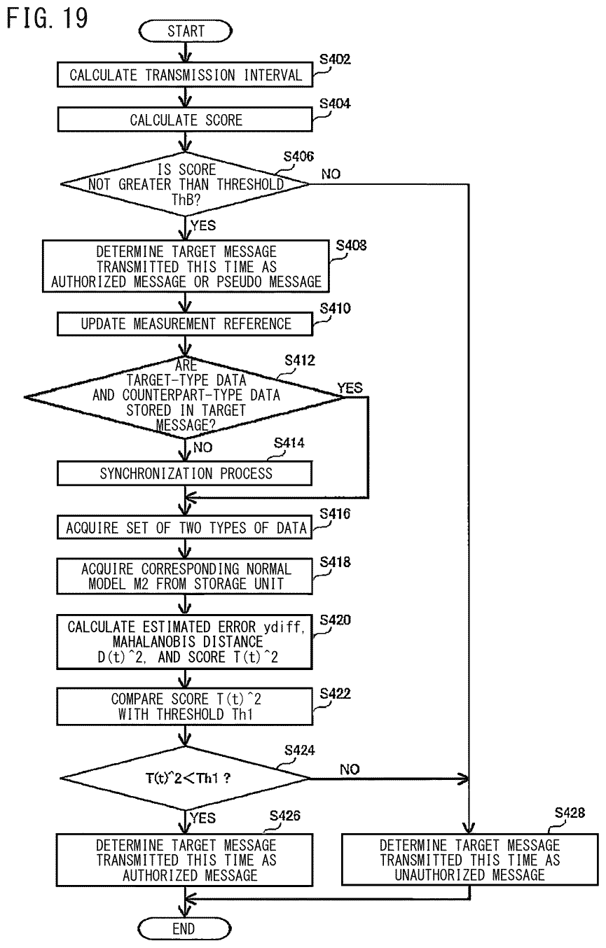

FIG. 19 is a flowchart of a procedure of operation performed when the gateway device according to the second embodiment of the present disclosure performs the determination process. FIG. 19 shows the details of the operation in step S306 in FIG. 18.

With reference to FIG. 19, the gateway device 103 calculates a transmission interval by subtracting the measurement reference from the reception time of the target message (step S402).

Next, the gateway device 103 calculates a score by substituting the calculated transmission interval into the score function Sc1 (step S404).

When the calculated score is greater than the threshold ThB (No in step S406), the gateway device 103 determines that the target message transmitted this time is an unauthorized message (step S428).

When the calculated score is not greater than the threshold ThB (YES in step S406), the gateway device 103 determines that the target message transmitted this time is an authorized message or a pseudo message (step S408).

Next, the gateway device 103 updates the measurement reference to the reception time of the target message transmitted this time (step S410).

Next, the gateway device 103 confirms whether or not both the target-type data (i.e., the monitoring target data) and the counterpart-type data (i.e., the correlation data) are stored in the target message (step S412).

Next, when both the monitoring target data and the correlation data are not included in the target message, i.e., when the monitoring target data and the correlation data are included in separate transmission messages (NO in step S412), the gateway device 103 performs a synchronization process on the monitoring target data and the correlation data (step S414).

Next, the gateway device 103 acquires a set of the two types of data, more specifically, a set of the monitoring target data and the correlation data from the target message, or acquires the newest set of the monitoring target data and the correlation data from the monitoring target data and the correlation data that have been subjected to the synchronization process (step S416).

Next, the gateway device 103 acquires, from the storage unit 52, a normal model M2 corresponding to the set of the monitoring target data and the correlation data (step S418).

Next, the gateway device 103 calculates an estimated error ydiff of the monitoring target data, based on the acquired set of the monitoring target data and the correlation data and on the normal model M2. Furthermore, the gateway device 103 calculates a Mahalanobis distance D(t)\hat{ }2, based on the calculated estimated error ydiff and on a distribution, of the estimated error ydiff, created by using the normal model M2. Moreover, the gateway device 103 calculates a score T(t)\hat{ }2, based on the calculated Mahalanobis distance D(t)\hat{ }2 and on a Mahalanobis distance D(t−1)\hat{ }2 that had just previously been calculated and stored in the storage unit 52 (step S420).

Next, the gateway device 103 compares the calculated score T(t)\hat{ }2 with the predetermined threshold Th1 (step S422).

Next, when the score T(t)\hat{ }2 is smaller than the threshold Th1, the gateway device 103 determines that the target message transmitted this time is an authorized message (step S426).

Meanwhile, when the score T(t)\hat{ }2 is not smaller than the threshold Th1, the gateway device 103 determines that the target message transmitted this time is an unauthorized message (step S428).

In the gateway device according to the second embodiment of the present disclosure, the monitoring unit 57 is configured to measure a transmission interval, based on the reception time of the target message. However, the present disclosure is not limited thereto. For example, the monitoring unit 57 may acquire the transmission time of the target message and measure a transmission interval, based on the acquired transmission time.

The gateway device according to the second embodiment of the present disclosure is configured to acquire a distribution of target message transmission intervals measured in a test vehicle. However, the present disclosure is not limited thereto. The gateway device 103 may accumulate transmission intervals measured in the vehicle 1 and create the distribution based on the accumulated transmission intervals.

The other configurations and operations are the same as those of the gateway device according to the first embodiment, and therefore, detailed description thereof is not repeated here.

It should be noted that part or all of the components and operations of the devices according to the first embodiment and the second embodiment of the present disclosure can be combined as appropriate.

The disclosed embodiments are merely illustrative in all aspects and should not be recognized as being restrictive. The scope of the present disclosure is defined by the scope of the claims rather than by the description above, and is intended to include meaning equivalent to the scope of the claims and all modifications within the scope.

The above description includes the features in the additional notes below.

[Additional Note 1]

A detection device configured to detect an unauthorized message in an in-vehicle network mounted in a vehicle, the detection device comprising:
a message acquisition unit configured to acquire one or a plurality of transmission messages in the in-vehicle network;
a data acquisition unit configured to acquire a set of a plurality of types of data that are included in the transmission messages acquired by the message acquisition unit and that correspond to the same time;
a storage unit configured to store therein a detection condition, the detection condition having been created in advance and based on a plurality of the sets that respectively correspond to a plurality of times;
a calculation unit configured to calculate an estimated error of the data of a type to be monitored in the set, based on the set acquired by the data acquisition unit and on the detection condition; and
a determination unit configured to determine whether or not the transmission message corresponding to the data of the type to be monitored is an unauthorized message, based on the estimated error calculated by the calculation unit and on an estimated error that was calculated in the past by the calculation unit, wherein
the data is sensor data,
the time is a reception time, a transmission time, or a creation time, and
the determination unit determines whether or not the transmission message corresponding to the data of the target type is an unauthorized message, based on the estimated error and on the estimated error calculated in the past, by using an analysis method according to CUSUM, MCUSUM, EWMA, or MEWMA.

[Additional Note 2]

A detection device configured to detect an unauthorized message in an in-vehicle network mounted in a vehicle, the detection device comprising:
a message acquisition unit configured to acquire one or a plurality of transmission messages in the in-vehicle network;
a data acquisition unit configured to acquire a set of a plurality of types of data that are included in the transmission messages acquired by the message acquisition unit and that correspond to the same time;
a storage unit configured to store therein a detection condition, the detection condition having been created in advance and based on a plurality of the sets that respectively correspond to a plurality of times;
a calculation unit configured to calculate an estimated error of the data of a type to be monitored in the set, based on the set acquired by the data acquisition unit and on the detection condition; and
a determination unit configured to determine whether or not the transmission message corresponding to the data of the type to be monitored is an unauthorized message, based on the estimated error calculated by the calculation unit and on an estimated error that was calculated in the past by the calculation unit, wherein the message acquisition unit, the data acquisition unit, the calculation unit, and the determination unit are implemented by a processor.

### REFERENCE SIGNS LIST

1 vehicle
12 in-vehicle network
13, 14 transmission line
51 communication processing unit
52 storage unit
53 data acquisition unit
54 detection unit
55 message acquisition unit
57 monitoring unit
58 distribution acquisition unit
64 detection unit
101, 103 gateway device
111 in-vehicle communication device
112 port
121 bus connection device group
122 control device
301 in-vehicle communication system

1. A detection device configured to detect an unauthorized message in an in-vehicle network mounted in a vehicle, the detection device comprising:
a message acquisition unit configured to acquire one or a plurality of transmission messages in the in-vehicle network;
a data acquisition unit configured to acquire a set of a plurality of types of data that are included in the transmission messages acquired by the message acquisition unit and that correspond to the same time;
a storage unit configured to store therein a detection condition, the detection condition having been created in advance and based on a plurality of the sets that respectively correspond to a plurality of times;
a calculation unit configured to calculate an estimated error of the data of a type to be monitored in the set, based on the set acquired by the data acquisition unit and on the detection condition; and
a determination unit configured to determine whether or not the transmission message corresponding to the data of the type to be monitored is an unauthorized message, based on the estimated error calculated by the calculation unit and on an estimated error that was calculated in the past by the calculation unit, wherein
the calculation unit calculates an evaluation value regarding authenticity of the data of the type to be monitored, based on the calculated estimated error and on a distribution of the estimated error created by using the detection condition, and
the determination unit determines whether or not the transmission message corresponding to the data of the type to be monitored is an unauthorized message, based on the evaluation value calculated by the calculation unit and on an evaluation value that was calculated in the past by the calculation unit.

2. (canceled)

3. A detection device configured to detect an unauthorized message in an in-vehicle network mounted in a vehicle, the detection device comprising:
a message acquisition unit configured to acquire one or a plurality of transmission messages in the in-vehicle network;
a data acquisition unit configured to acquire a set of a plurality of types of data that are included in the transmission messages acquired by the message acquisition unit and that correspond to the same time;
a storage unit configured to store therein a detection condition, the detection condition having been created in advance and based on a plurality of the sets that respectively correspond to a plurality of times;
a calculation unit configured to calculate an estimated error of the data of a type to be monitored in the set, based on the set acquired by the data acquisition unit and on the detection condition; and
a determination unit configured to determine whether or not the transmission message corresponding to the data of the type to be monitored is an unauthorized message, based on the estimated error calculated by the calculation unit and on an estimated error that was calculated in the past by the calculation unit, wherein
the determination unit calculates a moving average of the estimated error, based on the estimated error calculated by the calculation unit and on an estimated error that was calculated in the past by the calculation unit, and determines whether or not the transmission message corresponding to the data of the type to be monitored is an unauthorized message, based on the calculated moving average.

4. The detection device according to claim 1, wherein the detection condition is created based on the sets of a plurality of types of data that have a predetermined correlation.

5. The detection device according to claim 4, wherein
when there are a plurality of types of correlation data that are the data having the correlation with the data of the type to be monitored, one detection condition is created based on the data of the type to be monitored and on the plurality of types of the correlation data.

6. The detection device according to claim 4, wherein
when there are a plurality of types of correlation data that are data having the correlation with the data of the type to be monitored, a plurality of detection conditions are created based on the data of the type to be monitored and on the plurality of types of the correlation data.

7. The detection device according to claim 1, wherein the data is status data indicating a state.

8. The detection device according to claim 1, wherein the data acquisition unit acquires a set of the plurality of types of data respectively included in the transmission messages that are different from each other.

9. The detection device according to claim 8, wherein
the message acquisition unit stores, in the storage unit, the plurality of transmission messages having been acquired, and
the data acquisition unit acquires the set from the transmission messages stored in the storage unit.

10. The detection device according to claim 1, further comprising:
a monitoring unit configured to monitor the transmission messages in the in-vehicle network; and
a distribution acquisition unit configured to acquire a distribution of transmission intervals of the transmission messages, wherein
the determination unit detects an unauthorized message, based on a monitoring result by the monitoring unit and on the distribution acquired by the distribution acquisition unit,
with respect to a transmission message that has been determined, based on the distribution by the determination unit, as not to be treated as an unauthorized message, the calculation unit calculates the estimated error of the data stored in the transmission message, and
the determination unit determines whether or not the transmission message, which has been determined, based on the distribution, as not to be treated as an unauthorized message, is an unauthorized message, based on the estimated error calculated by the calculation unit and on the estimated error that was calculated in the past by the calculation unit.

11. A vehicle comprising the detection device according to claim 1.

12. A detection method to be performed in a detection device, the detection device including a storage unit and configured to detect an unauthorized message in an in-vehicle network mounted in a vehicle, the detection method comprising:
acquiring one or a plurality of transmission messages in the in-vehicle network; and
acquiring a set of a plurality of types of data that are included in the acquired transmission messages and that correspond to the same time, wherein
the storage unit stores therein a detection condition, the detection condition having been created in advance and based on a plurality of the sets that respectively correspond to a plurality of times,
the detection method further comprising:
calculating an estimated error of the data of a type to be monitored in the set, based on the acquired set and the detection condition; and
determining whether or not the transmission message corresponding to the data of the type to be monitored is an unauthorized message, based on the calculated estimated error and an estimated error that was calculated in the past, wherein
the calculating an estimated error includes calculating an evaluation value regarding authenticity of the data of the type to be monitored, based on the calculated estimated error and on a distribution of the estimated error created by using the detection condition, and
the determining whether or not the transmission message is an unauthorized message includes determining whether or not the transmission message corresponding to the data of the type to be monitored is an unauthorized message, based on the calculated evaluation value and on an evaluation value that was calculated in the past.

13. A non-transitory computer-readable storage medium having, stored therein, a detection program to be used in a detection device, the detection device including a storage unit and configured to detect an unauthorized message in an in-vehicle network mounted in a vehicle, the detection program causing a computer to function as:
a message acquisition unit configured to acquire one or a plurality of transmission messages in the in-vehicle network; and
a data acquisition unit configured to acquire a set of a plurality of types of data that are included in the transmission messages acquired by the message acquisition unit and that correspond to the same time, wherein
the storage unit stores therein a detection condition, the detection condition having been created in advance and based on a plurality of the sets that respectively correspond to a plurality of times,
the detection program further causing the computer to function as:
a calculation unit configured to calculate an estimated error of the data of a type to be monitored in the set, based on the set acquired by the data acquisition unit and on the detection condition; and
a determination unit configured to determine whether or not the transmission message corresponding to the data of the type to be monitored is an unauthorized message, based on the estimated error calculated by the calculation unit and on an estimated error that was calculated in the past by the calculation unit, wherein
the calculation unit calculates an evaluation value regarding authenticity of the data of the type to be monitored, based on the calculated estimated error and on a distribution of the estimated error created by using the detection condition, and
the determination unit determines whether or not the transmission message corresponding to the data of the type to be monitored is an unauthorized message, based on the evaluation value calculated by the calculation unit and on an evaluation value that was calculated in the past by the calculation unit.
